(19) United States
(12) Patent Application Publication
(10) Pub. No.: US 2023/0012657 A1
(43) Pub. Date: Jan. 19, 2023

(54) ELECTROLYTIC REACTION SYSTEM FOR PRODUCING GASEOUS HYDROGEN AND OXYGEN

(71) Applicant: ASA-Energie GmbH, Ohlsdorf (AT)

(72) Inventors: Oleksii REBROV, Malmoe (SE); Michael HEIDER, Micheldorf (AT); Johannes ASAMER, Ohlsdorf (AT)

(73) Assignee: ASA-Energie GmbH, Ohlsdorf (AT)

(21) Appl. No.: 17/778,230

(22) PCT Filed: Nov. 20, 2020
(86) PCT No.: PCT/AT2020/060413

§ 371 Date: May 19, 2022

(30) Foreign Application Priority Data
Nov. 22, 2019 (AT) A51011/2019

(51) Int. Cl. C25B 1/04; C25B 9/015; C25B 9/15; C25B 11/02; C25B 15/08; C25B 9/63

(52) U.S. Cl. CPC C25B 1/04; C25B 9/015; C25B 9/15; C25B 11/02; C25B 15/08; C25B 9/63

(57) ABSTRACT

An electrolytic reaction system for generating gaseous hydrogen and oxygen includes a reaction chamber for accommodating an electrolyte as well as an electrode arrangement, which is formed of anodic and cathodic electrodes. Between lateral surfaces of electrodes arranged to be spaced apart from one another, at least one flow channel for the electrolyte is formed, which extends between a first axial end for admitting the electrolyte into the electrode arrangement and a second axial end for discharging the electrolyte out of the electrode arrangement. The at least one flow channel has at least one first flow cross-section and at least one second flow cross-section, wherein the second flow cross-section has a smaller size than the first flow channel, and the comparatively smaller second flow cross-section is formed in a partial section of the at least one flow channel closest to the second axial end of the electrode arrangement.

### CROSS REFERENCE TO RELATED APPLICATIONS

This application is the National Stage of PCT/AT2020/060413 filed on Nov. 20, 2020, which claims priority under 35 U.S.C. §119 of Austrian Application No. A 51011/2019 filed on Nov. 22, 2019, the disclosure of which is incorporated by reference. The international application under PCT article 21(2) was not published in English.

### BACKGROUND OF THE INVENTION

### 1. Field of the Invention

The invention relates to an electrolytic reaction system for generating gaseous hydrogen and oxygen as it is specified in the claims.

### 2. Description of the Related Art

WO 2011/131868 A1 discloses an electrolysis device for generating gaseous hydrogen and oxygen from an aqueous medium. The electrolysis device comprises electrodes of funnel-shaped and/or frustum-shaped design, which electrodes are arranged coaxially with respect to a vertical axis. Between the lateral surfaces of the electrodes facing one another, gap widths which remain constant with respect to the vertical direction are formed for forming cone-shaped electrolyte holding chambers.

RU 2 227 817 C1, US 2010/320083 A1 and U.S. Pat. No. 4,113,601 A likewise disclose electrolysis devices with funnel- and/or frustum-shaped electrodes, which are arranged coaxially to a common vertical axis and are stacked in one another. In this regard, the gap widths between the lateral surfaces of neighboring electrodes are also formed to be constant.

WO 2018/124643 A1 describes a device for producing hydrogen water by means of hydrogen being dissolved in water. This device for hydrogen water comprises an electrolyte container with a flow channel tapering in the vertical direction from the top downwards for dissolving hydrogen in the water. The hydrogen is generated by means of electrolysis of untreated water fed into the device in an electrolysis part. The electrolysis part comprises an ion exchange membrane, a first electrode part, in which the oxidation reaction occurs, and a second electrode part, which has a different polarity than the first electrode part and which generates the reduction reaction. Addtionally, an EDLC forming electrode part is formed, which is arranged in the electrolyte cntainer with the gap tapering from the top downwards, at a distance from the second elctrode part of the electrolysis part and has a potential that is lower than the potential of the second electrode part within a range which prevents the electrolysis between the second electrode part and the EDLC forming electrode part. The electrolysis of water to generate hydrogen and oxygen thus occurs in a first section of the device and the generated hydrogen is dissolved in the water in a flow channel tapering in the vertical direction from the top downwards, which flow channel may additionally have a spiral element with a changing slope for an even better mixing of hydrogen and water.

RU 2 253 700 C1 and U.S. Pat. No. 3,990,962 A disclose further electrolysis devices with hollow-cylindrical electrodes coaxially placed into one another.

WO 2011/038432 A1 describes an electrolysis device with hollow-cylindrical electrodes coaxially placed into one another, wherein at least one electromagnetic coil is formed in the upper and/or lower axial end section of this electrode arrangement. The at least one electromagnetic coil is provided for supporting the detachment of gas bubbles adhering to the electrode surfaces.

US 2004/108203 A1 discloses an electrolysis device for converting water into hydrogen and oxygen. The electrolysis device comprises electromagnetic coils, the electromagnetic field of which is to support the detachment of gas bubbles from the electrodes.

### SUMMARY OF THE INVENTION

The invention particularly relates to a system for generating gaseous hydrogen and oxygen in a highly efficient manner by means of an electrolysis process in the reaction chamber, wherein the goal of an optimal utilization of the electrical energy used for splitting water into gaseous hydrogen and oxygen is pursued and achieved. Furthermore, the invention relates to the utilization of said gases, in particular to the utilization of the energy carrier hydrogen for chemical combustions and/or oxidations. In particular, the water is broken down into gaseous hydrogen and oxygen by means of electrolysis, whereupon the chemical energy carrier hydrogen is transformed into thermal energy and/or kinetic energy by means of a combustion process. In this regard, the water is broken down into the mentioned gases with as good an energy balance as possible. Furthermore, using this electrolysis process, large amounts of electrolytically generated, gaseous hydrogen and oxygen can be produced within relative short periods of time.

In this process, the technology according to the invention reduces the used and/or necessary electrical energy, which is required for splitting water into hydrogen and oxygen in order to achieve the best possible and/or economically positive energy balance upon production of the chemical energy carrier and/or in order to realize an economic and simultaneously environmentally compatible utilization of the gaseous fuel hydrogen and/or the thermal or kinetic energy obtained therefrom.

The technology according to the invention was created with the goal to generate hydrogen gas and oxygen gas preferably from naturally occurring water or from aqueous, electrolytic solutions, namely at an amount which makes it possible to provide a consumer with the generated chemical energy carrier hydrogen without large-volume or technically complex interim storage, in particular in a usage device and/or a conversion device. The corresponding usage device then converts this chemical energy carrier and/or fuel into the respectively required form of energy by means of a combustion process, in particular into thermal and/or kinetic energy or also into electrical energy.

The chemical energy carrier, obtained according to the invention, in the form of hydrogen gas, in particular the gaseous hydrogen in connection with the gaseous oxygen, in this regard makes a utilization and/or energy conversion possible without the emission values which usually occur during the combustion of fossil fuels. When using the system according to the invention, only steam or condensed water and other trace elements occur in addition to the respective form of energy desired. The byproducts in case of the thermal combustion of hydrogen gas, in particular when using its energy, are known to be significantly more environmentally friendly in comparison to fossil fuels. The primary waste product of the combustion process of hydrogen namely is only steam and/or water, which can be passed into the environment without problems. In this regard, this waste product is cleaner than many other water resources and/or the electrolytically generated oxygen is cleaner and/or more concentrated that the other air in the environment.

The system according to the invention and the method measures according to the invention are the result of numerous test series and experiments with a variety of set ups and modes of operation of said set ups for producing hydrogen according to the principle of electrolysis, which, with respect to its physical principles, has been known for over a century.

The electrolysis of water is basically a very simple, known principle, in which the splitting of water into gaseous hydrogen and oxygen is effected by means of two and/or by means of multiple electrodes located in an electrolyte or water bath and by applying electrical energy, in particular direct current voltage. As a matter of principle, this process is nothing new. However, the known processes are relatively inefficient as they required significantly more primary energy for splitting than was available by using the thermal and/or chemical energy of the generated gases and/or by a combustion process of the produced gas later on. Therefore, an economically fairly negative and/or poor energy balance has been achieved to date. Apart from that, such a great amount of electrical energy had to be added that the resulting advantages were not identifiable and/or lost, as electrical energy is generated at a high ratio from the combustion of fossil fuels. In terms of the environment, the systems known from the prior art have thus not brought about any excellent advantages. For this reason, the utilization of hydrogen and its energy potential have never become prevalent in practice and/or only became prevalent in very limited fields of application.

From the previously known prior art, numerous embodiments of electrolysis apparatuses are known. However, it appears that none of these devices is capable of being used for a wide range of applications. For example, for the energy supply of motor vehicles, power generators, or heating systems, these previously known designs are obviously not satisfactory a drive and/or supply systems based on electrolytically obtained hydrogen and/or based on a hydrogen-oxygen mixture are standardly non-existent and/or can only be found at an experimental stage.

The technology according to the invention now makes it possible to provide, with a special set up and/or with special measures, the gaseous hydrogen and oxygen in the respective amount required from water and/or from water-based solutions, i.e. providing it without large-volume and/or technically complex interim storage in a demand-based manner and with fast reactions. In particular, when producing the chemical energy carrier, in particular when obtaining the hydrogen gas by means of electrolysis, an economically positive energy balance is achieved, and the generation of the chemical energy is ensured with a reduced use of primary energy. In this regard, the thermal and/or heat energy that can ultimately be generated, which is obtained from the zero-emission combustion of hydrogen and oxygen, can be used in a variety of ways. Almost all devices in a household or in industrial use, such as for example ovens, grills, heaters, air conditioning systems, and also power generators, can be driven with this chemical energy and in doing so, provide for a conversion into electrical, kinetic, and/or thermal energy or for a conversion into other forms of energy. Hydrogen and oxygen may also be used to operate almost all conventional internal combustion engines.

Electrolysis technology, in particular the electrolytic reaction system according to the invention, offers the chance to utilize the chemical energy and/or the thermal and/or heat energy from hydrogen and oxygen without greatly impacting the environment as it happens due to the combustion of fossil fuels common nowadays.

The relevant technology is safer than many systems known to date for operating motors, for generating current, for heating purposes, and the like. Each of these systems require fuels contained in tanks and/or feed line systems for operation. In these components, an incomparably great amount of combustion energy is stored and/or kept available. In failures, which occur time and again in practice, this relatively often causes grave problems. In particular, in some cases, unforeseen consequences are caused by the direct storage of the fuel. Most times, such failures are relatively grave and/or can only be somewhat brought under control with relatively great technical effort.

In the system according to the invention only a relatively small, in particular a substantially smaller, amount of combustible gas is stored in the system. The only storage in tanks or in line takes place in the form of relatively noncritical water-based solutions or in the form of pure water, which is chemically and/or with respect to the environment unproblematic and is of course incombustible. Additionally, effective safety devices can easily be assigned to the production process, in particular to the reaction chamber, which safety devices are reliable and cost-effective. The electrolysis system according to the invention, which particularly has fast reactions and/or is efficient, makes it possible to only have to store relatively small amounts of gas. In particular, a storage and/or buffer volume comprising the reaction chamber and the feed line systems is sufficient in most cases. Due to this fact, this electrolysis system and/or the specified device for energy conversion is easily manageable and the system according to the invention is to be deemed very safe.

The underlying object of the present invention is to create an improved, electrolytic reaction system. In particular, the aim is an electrolytic system for breaking down water or water-based solutions into gaseous hydrogen and oxygen, the electrolytic system having an increased efficiency and/or a high degree of effectiveness with respect to the supplied electrical energy amount and the generated and/or converted chemical and/or thermal, or kinetic energy amount.

This object is achieved by an electrolytic reaction system according to the features of the invention.

A surprising advantage resulting from the features of the invention consists in that using such an electrolytic reaction system, a good ratio of supplied electrical energy and obtained chemical energy can be achieved. This is achieved mostly due to the constructional combination and the technical interaction between the electrode arrangement and the flow channels defined by the electrodes of the electrode arrangement, which flow channels taper and/or become more narrow at at least one location with respect to the flow direction of the electrolyte. Due to the overlapping vibrations of the electrolyte accelerated in the flow channels and/or due to the combined effects from the electrical fields of the electrode arrangement, optimal preconditions are created for producing hydrogen and/or oxygen or a corresponding mixture at a good degree of effectiveness.

A surprising, advantageous interaction inter alia consists in that the gas bubbled developing during the electrolysis process, in particular the respective hydrogen and oxygen bubbles, are detached in an improved and/or accelerated manner from the electrode surfaces. Additionally, shorter degassing times of the respective gases out of the electrolyte can be achieved. As a consequence thereof, it results that the available electrodes and/or their effective surfaces are each available at a maximum for the conversion process and as intense a contacting as possible with the electrolyte always exists. In particular, gas barriers between the electrodes and the electrolyte are kept as small as possible and/or broken down as quickly as possible.

A particularly useful interaction effect consists in that the gas bubbles, which occur in an increasingly greater number and/or density along the flow direction, particularly become more and more and/or are present in a more cumulated manner in the electrolyte towards the top, are removed comparatively quicker and/or more intensely from the surfaces of the electrodes, because they are conducted out of the at least one gap and/or flow channel between adjacent electrode surfaces at an increasingly higher flow speed. This effect is achieved by the at least one flow channel designed according to the claims, in particular by the shape and/or orientation of the electrodes. In further consequence, the intense detaching and/or the increasingly accelerated removal of developing hydrogen and/or oxygen gas bubbles helps achieve that the current density in the electrode arrangement and/or in the electrolyte becomes more uniform and/or consistent and thereby, an effective electrolysis process and/or a high performance of the reaction system can be achieved. The flow speed of the electrolyte, which increases in the direction towards the discharge region, within the at least one tapering flow channel therefore has positive effects on the detachment intensity of the gas bubbles, on the removal speed of the gas bubbles, and on the obtainable current density in the electrode arrangement and/or in the electrolyte.

In particular, the removal of the gas content in the electrolyte is supported and/or accelerated, such that the effectiveness and/or efficacy of the electrolysis process is always kept as high as possible. Overall, an improved, electrolytic reaction system is created thereby, which provides relatively large amounts of electrolytically obtained, gaseous hydrogen and oxygen in relatively short process times. Furthermore, the electrolysis system according to the invention can be set up relative cost-effectively and thus has a high profitability and/or enables a practical usage.

The following as well as the preceding information on the effects and/or impact is to be understood as exemplary information and does not claim to be exhaustive. Furthermore, not all of the effects mentioned in each case have to occur. Additionally, the mentioned information on the effects and/or impacts are not subject to any weighting, and the explanations of the various connections are partly to be deemed as most probable. In part, phenomena and/or interactions which cannot and/or can barely be explained exist, the technical backgrounds of which are not obvious and/or are difficult to explain for the general experts. The corresponding results are partly based on numerous test series and on empirical changes of parameters of the electrolytic system.

Due to the design according to an embodiment, the tapering flow channel can have a mechanically robust construction. Furthermore, as simple an installation as possible is achieved thereby and/or as simple a structure as possible of the electrolytic reaction system is created thereby, whereby its initial costs can be kept relatively low.

A possible embodiment is also advantageous. Thereby, pronounced tapers in the at least one flow channel are obtainable. It may be sufficient if merely the inner or the outer lateral surface is inclined with respect to the central axis and/or with respect to the cylinder and/or vertical axis of the electrode arrangement. If both the radially inner and the radially outer limiting surface of the flow channel extend at an angle to the cylinder and/or vertical axis and/or are oriented at an angle to a vertical, a nozzle-like tapering of the flow channel may be formed relatively intensely. In this case, both the anodic and the cathodic limiting surface of the flow channel extend at an angle to the cylinder and/or vertical axis. Additionally, a flow channel with a relatively strong taper can be created thereby with a relatively small incline of the lateral surfaces of the electrodes. This facilitates the detachment of both hydrogen bubbles and oxygen bubbles from the cathodic and/or anodic effective surfaces of the electrodes.

A design according to another embodiment is also useful. Thereby, as cost-effective a production as possible of the electrode arrangement and in further consequence of the electrolysis system can be facilitated without notable losses in performance being caused.

By means of an advantageous advancement according to another embodiment, a fluidically favorable electrode arrangement with optimized performance can be constructed. Additionally, as cost-effective a production as possible can be achieved, in particular if production methods like casting and/or turning are used.

A measure according to a further embodiment is also advantageous. A flow channel for the electrolyte tapering and/or becoming more narrow along the flow direction can also be advantageously realized in a simple yet effective manner by a defined angulation and/or orientation between directly adjacent electrodes and/or electrode surfaces.

According to the advantageous measure according to another embodiment, it is provided that in the axial direction of the virtual cylinder and/or vertical axis, at least one electromagnetic coil is arranged above and/or below the electrode arrangement, the electromagnetic field of which acts on the electrolyte and on the electrode arrangement when supplied with electrical energy. Thereby, the current density is increased and thus, the efficiency of the electrolysis process is facilitated. Moreover, minimal oscillations and/or vibrations of the electrodes and the electrolyte can be generated, which can support the electrolysis process inter alia due to a more intense detachment of gas bubbles on the electrodes and/or due to a more intense degassing of the electrolyte.

Furthermore, it may be provided that the at least one reaction chamber has an essentially hollow-cylindrical or hollow-prismatic body shape, and its virtual central axis, in particular a lateral surface of the reaction chamber, is oriented to be vertical or approximately vertical. Thereby, a fluidically favorable body shape and orientation is created in order to achieve defined and/or directed flows in the electrolyte and in the chamber sections for the accumulating gases. Additionally, electrolytic reaction systems with a relatively compact construction and with relatively high performance can be achieved thereby.

According to an advancement according to another embodiment, it may be provided that the reaction chamber comprises an essentially hollow-cylindrical or hollow-prismatic holding container, in which the at least tubular, or alternatively star-shaped, electrode arrangement is arranged. Thereby, a type of container-within-container arrangement is present, which also favors the performance of the electrolysis process. Particularly, this creates a division into a container for receiving the electrolyte and electrode and a container and/or chamber arrangement surrounding said container for receiving the mentioned components as well as for the accumulation of the developing gases.

Additionally, a design according to a further embodiment may be provided, in which the holding container for the electrolyte and for the at least one electrode arrangement is designed to be open in the upper end section and the lateral and/or cylinder surface of which is arranged so as to be spaced apart from the inner wall surfaces of the reaction chamber. Thereby, as large a degassing cross-section as possible is present, which contributed to as short a degassing time as possible and to as intense a degassing as possible. Furthermore, a holding container for the electrolyte is created, which offers an unhindered and/or generous overflow for the electrolyte fluid and/or for the possibly occurring electrolyte foam. Such an electrolyte foam usually forms on the electrolyte fluid, in particular at the surface of the electrolyte bath and partially hinders degassing of the gas contents in the electrolyte. Due to the continuous destruction and/or avoiding a whitecap on the electrolyte bath, which in particular can be achieved by simple diversion of the same, the efficiency of the system can be kept as high as possible.

Moreover, due to the measures according to the embodiment, it is advantageously easily possible to create a defined electrolyte circuit. In particular, electrolyte fluid can be supplied and discharged continuously or discontinuously with respect to the holding container, wherein an excess amount of electrolyte fluid can flow off again in a cascade-like manner over the upper edge of the holding container and possibly can be fed back into the receiving and/or electrolyte container after a cleaning and/or cooling and/or treatment process. Thus, a recirculation of the electrolyte fluid can take place in a simple manner, whereby an intense and quick degassing, inter alia, is achieved. In particular, a reaction and/or holding container is created thereby, in which the expansion and/or increase in volume of the electrolyte induced by the electrolytic process can easily be compensated and/or regulated via the overflow edge of the holding container. Alternatively in combination therewith, the excess amount of electrolyte fluid arising from a continuous or discontinuous electrolyte supply into the holding container can flow out of the electrolyte container in a defined manner and, according to an advantageous embodiment variant, be fed back into the holding container. Moreover, this causes a kind of “electrolyte fall” over the outer and/or over inner walls of the holding container. In this regard, this electrolyte drain and/or electrolyte fall may take place on the outer surfaces of the holding container and/or on central, inner wall sections of the holding container, by the holding container for the electrolyte having a hollow-cylindrical or multiply hollow-cylindrical body shape, in particular is formed to be cascade-like and/or has holding containers placed into one another in a coaxial manner

By measures according to another aspect of the invention, as well, a fluidically favorable embodiment is created, which improves the efficiency and/or the reaction time of the electrolytic reaction system.

The measures according to other embodiments are also particularly advantageous as thereby, a particularly good electrolysis effect can be attained and/or as intense a technical interaction as possible is constructed. In particular, the electromagnetic field of the at least one electromagnetic coil may have a particularly intense effect on the electrode arrangement and on the electrolyte and thereby improve the progress and/or the efficiency in the electrolytic process.

Thus, on the one hand, the electromagnetic field of the at least one electromagnetic coil has a favorable effect on the splitting process. Furthermore, the mechanical vibrations occurring in the at least one electromagnetic coil are also introduced to the electrolyte and/or the electrode arrangement as directly as possible. Thereby, the detachment process of the gas bubbles from the electrodes and/or the degassing process from the electrolyte is improved and/or accelerated. The mentioned effects are associated with an improvement, in particular with an increase in efficiency and performance, of the electrolytic reaction system.

Moreover, an advancement according to another embodiment is advantageous, as such an electromagnetic coil generates an electromagnetic field, which has a favorable effect on the electrolytic process, in particular increases its efficiency. In particular, a relatively intense and relatively uniform application of the electrode arrangement with the electromagnetic field of said coil, which generates a pulsing field and/or an alternating field, is achieved thereby. In this regard, the electromagnetic field circulates about the vertical and/or central axis of the electrode arrangement and/or the reaction chamber, which axis additionally extends through the core and/or the center of the essentially annular coil.

The embodiment according to other aspects of the invention describes an advantageous and/or particularly effective embodiment of the electromagnetic coil. Thus, the effectiveness and/or total output of the electrolytic reaction system can be favorably influenced.

A design according to another embodiment is also of particular advantage as thereby, the detachment and/or degassing process in the electrolyte fluid is improved and/or accelerated. In particular, a recirculation can be formed and/or a flow can be generated thereby, by means of which the gas bubbles are detached from the electrode surfaces in a better manner, in particular relatively thoroughly and quickly. Furthermore, the degassing process with respect to the gas bubbles present in the electrolyte fluid into a gas chamber situated above the electrolyte fluid is supported. In this regard, the supply and/or refilling of the electrolyte in the bottom section of the reaction chamber and/or of the reaction chamber takes place periodically, aperiodically and/or controlled based on need. It is essential that due to this supply and/or refilling a turbulence and/or flow is formed in the electrolyte.

Independently or in combination, the previously mentioned advantageous effects and/or technical effects are also achieved by means of the measures according to a further embodiment. The means used to cause turbulence in the electrolyte and/or for creating a flow in the electrolyte may therefore be achieved by the electrolyte itself and/or by adding gaseous media, for example air or nitrogen. If other, non-combustible gases are added, such as ambient air or nitrogen for example, the combustion value of the electrolytically generated hydrogen gas can advantageously be regulated, in particular reduced. By admixing non-combustible gases directly in the electrolyte in this way, therefore, a turbulence and/or a flow is created in the electrolyte bath on the one hand and the combustion value or combustion rate of the electrolytically generated hydrogen gas is reduced on the other hand. As a result, the quantity of energy and/or explosivity, in particular the combustion rate of the electrolytically generated gas and/or gas mixture, can be reduced to a level suitable for use in virtually standard internal combustion engines easily and with relatively few problems. Additionally, optimal mixtures of gases for subsequent uses can be prepared.

Also of advantage is an advancement according to another embodiment as a kind of spray and/or diffusor effect is achieved, which causes a flow distribution in the electrolyte which is as uniform and intense as possible. In particular, this causes a degassing that is as complete and uniform as possible with respect to the gas bubbles present in the electrolyte and/or with respect to the gas bubbles adhered to the electrode surfaces. Furthermore, this enables the density of foreign gas, in particular the quantity of gases blasted and/or introduced into the electrolyte per defined electrolyte volume, to be kept low and/or homogenized, thereby keeping the electrolysis performance high.

Another embodiment for shortening the degassing times from the fluid and for intensifying the contact between the electrolyte and the electrode plates is achieved using the measures according to a further aspect of the invention. In particular, this allows effecting a turbulent flow, in particular a flow of the electrolyte that whirls and/or helically extends upwards, with relatively little technical effort and also at the lowest possible costs.

As a result of the measures according to another embodiment, however, the degassing effect and the degassing performance of the electrolytic reaction systems is improved. Particularly if the electrolyte fluid continuously or discontinuously flows over the overflow edge, a sort of electrolyte fall and/or “waterfall” is obtained, by means of which an intensive and/or effective degassing measure is created, as already explained above. A corresponding overflow and/or discharge of the electrolyte can be achieved, in this regard, by a forced supply or refill of electrolyte fluid and/or may be caused and/or induced or determined due to the expansion in the volume of the electrolyte fluid during the electrolysis process.

A structurally and/or constructively simple overflow edge is created by means of the measures according to a further embodiment. Furthermore, this also results in a relatively homogeneous and/or uniform electrolyte overflow so that the most intensive degassing and/or separation possible is obtained between the electrolyte fluid and the gases and/or gas bubbles contained in the electrolyte fluid. Amongst other things, this is made possible by the spread of the electrolyte fluid over a relatively large surface area.

However, a design according to another embodiment is also advantageous as there is always an intensive degassing and/or a sufficiently large gas chamber is available. Furthermore, this allows preventing an overpressure in the reaction chamber and/or preventing a defined pressure value from being exceeded. In particular, a specific pressure level is maintained inside the reaction chamber as a result, at which the expansion of the electrolyte fluid caused by electrolysis is offset or at least approximately compensated by discharging a defined amount of electrolysis fluid. In particular, a defined degassing volume is maintained inside the reaction chamber thereby, and/or a defined gas pressure in the gas chamber of the reaction chamber is not exceeded.

Also of advantage is a design according to another embodiment as thereby, quantities of gas contained in the overflowing and/or discharged electrolyte are kept in the system and are therefore virtually not lost. Furthermore, a turbulence and/or flow builds up in the electrolyte container due to the fact that the electrolyte is recycled, as a result of which the outflow and/or removal of the gas contents from the liquid electrolyte is improved and/or accelerated.

As a result of the measures according to another embodiment, hydrogen gas which primarily collects in the top section of the reaction chamber is easily yet reliably sucked out or discharged via the electrolyte outflow. In particular, this prevents the electrolytically obtained hydrogen gas from being fed away via the discharge and/or intake for the electrolytic fluid and/or getting into a coolant circuit for the electrolyte. The electrolytically generated hydrogen gas or hydrogen-oxygen mixture is therefore available to the respective consumer and/or user of the hydrogen and/or oxygen gas. This also makes allowance for more stringent safety requirements because a discharge of hydrogen gas into channels and/or regions other than into the gas outlet region provided therefor can be prevented and/or minimized in a technical simple yet effective manner

Also of particular advantage are the measures according to a further embodiment as a recirculation is achieved in the electrolyte fluid as a result, which accelerates and/or improves a degassing process. Another major advantage resides in the fact that a simple regulation of the electrolyte fluid is associated with this. In particular, a cooling and/or limiting of the temperature for the electrolyte fluid can be easily achieved thereby. In this regard, the corresponding cooling process is accomplished by supplying a relatively small amount of energy because the usual ambient temperatures are generally sufficient to keep the electrolyte fluid at a temperature level that is favorable for the electrolysis process and/or in a satisfactory temperature range. An advantageous temperature range exists when the electrolyte fluid is kept within a temperature range below 60° C., preferably in a temperature range of between 20° C. and 50° C., in particular between 28° C. and 43° C.

According to an advancement, it may be provided that in the base or casing section of the reaction chamber, in particular of a holding container for the electrolyte, at least one passage opening is formed, in particular a plurality of passage openings arranged in a distributed manner are formed, for ambient air to be introduced into a holding container for the electrolyte and/or for gaseous nitrogen to be blasted into the electrolyte. On the one hand, a cooling and/or turbulence of the electrolyte fluid is achieved as a result and associated therewith, the degassing speed and/or the degassing efficiency with respect to electrolytically generated gas contents in the electrolyte fluid is increased. On the other hand, however, a simple regulation of the combustion and/or energy value of the gas mixture in the electrolytic reaction system is achieved. In particular, by regulating the quantity of ambient air and/or gaseous nitrogen introduced, its quantity of energy and/or combustion value, in particular its combustion rate, can be adjusted such that a problem-free combustion is made possible in standard consumers, such as in internal combustion engines or heating devices, for example. The gases introduced therefore produce a dual effect and/or a multiple effect, wherein the cumulative effects have a surprisingly high positive impact.

A further advantageous embodiment results in a multiple use and/or an advantageous application. In particular, the negative pressure which is built up by a consumer or its unit, e.g. a vacuum pump or a charging device for the combustion chamber (e.g. a turbocharger), is also used for supporting and/or accelerating degassing and/or the detaching of gas in the electrolytic reaction system. In this regard, the respective negative pressure built up by the respective consumer and/or its fuel supply can be kept in a specific range regarded as optimal using any regulating measures known from the prior art.

The measures according to another embodiment are of advantage as zones are defined thereby, in which a comparatively strong and/or intensive electromagnetic field is present, and moreover, zones are created in which the intensity of this field is comparatively lower. These non-homogeneous field strengths, i.e. increasing and decreasing with respect to the ring circumference, have a corresponding positive effect on the effectiveness and/or the overall performance of the electrolytic reaction system.

Furthermore, the technical measures according to another embodiment may be provided. In this regard, it is advantageous that thereby, the electrode arrangement and/or its electrodes has and/or fulfills the properties of a magnetic core, in particular a metal core, for the hollow-cylindrical coil. In this regard, the magnetic flux flowing through the receiving chamber and/or the inner reaction chamber is subject to a temporal change and thus leads to an electromagnetic induction on and/or in the electrodes. Since the individual electrodes are arranged at radially different diameter positions, different electrical potentials are built up, which may support the electrolysis process.

A design according to another embodiment is also useful as thereby, as intensive an electromagnetic interaction as possible can be established between the electrode arrangement and the hollow-cylindrical coil outwardly surrounding the electrode arrangement.

An advantageous advancement achieves as intensive a degassing of the electrolyte as possible, which degassing device is advantageously positioned particularly subsequent to the perfusion of the electrode arrangement. The effectiveness and/or performance of the electrolytic reaction system may be additionally increased thereby.

By an advantageous embodiment of the degassing device, a relatively thin fluid film and/or an electrolyte layer distributed flatly can be formed in a simple yet effective manner, whereby the separation of the gas bubbles from the electrolytic is facilitated. In this regard, the corresponding degassing device may be implemented in a constructionally simple and thus cost-effective manner Furthermore, a separate energy supply is not necessary for operating this degassing device as the electrolyte can flow off downwards due to the gravitational effect.

According to an advancement, it is possible to utilize the complete circumferential section of the receiving and/or electrolyte container and to thus achieve as intensive a degassing of the electrolyte as possible.

By means of the further measures according to another embodiment, a plurality of increasing and decreasing descent sections for the electrolyte can be created, which effect a mixing of the electrolyte and are thus able to additionally improve the degassing effect of the degassing device.

### BRIEF DESCRIPTION OF THE DRAWINGS

For the purpose of better understanding of the invention, it will be elucidated in more detail by means of the figures below. The embodiments shown in FIGS. 1-10 do not represent designs according to the invention.

These show in a respectively very simplified schematic representation:

FIG. 1 a fundamental diagram of one embodiment of the electrolytic reaction system, illustrating a plurality of technical embodiment and/or advancement options;

FIG. 2 a perspective view of a first embodiment of the electrolytic reaction system;

FIG. 3 a plan view illustrating an electrode arrangement with plate-shaped electrodes fanned out in a star-shaped arrangement;

FIG. 4 a plan view of a further embodiment of a star-shaped electrode arrangement comprising plate-shaped electrodes having a cross-section formed in a wedge shape or sector shape;

FIG. 5 an embodiment of an electromagnetic coil as it is used in the electrolytic reaction system;

FIG. 6 a further embodiment of an electrolytic reaction system in a longitudinal section;

FIG. 7 the electrolytic reaction system according to FIG. 6, viewed in section along line VII-VII in FIG. 6;

FIG. 8 a plan view of a further embodiment of an electrode arrangement inside an electrolytic reaction system;

FIG. 9 a further embodiment of an electromagnetic coil as it may be used in the electrolytic reaction system;

FIG. 10 a further embodiment of the electrolytic reaction system;

FIG. 11 an electrode arrangement in a simplified vertical section, having tubularly formed electrodes with electrode surfaces oriented at an angle and/or at an incline towards one another.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, are to be analogously transferred to the new position. Furthermore, individual features or combinations of features from the various exemplary embodiments presented and described may also constitute independent inventive solutions or solutions according to the invention.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7 or 3.2 through 8.1 or 5.5 through 10.

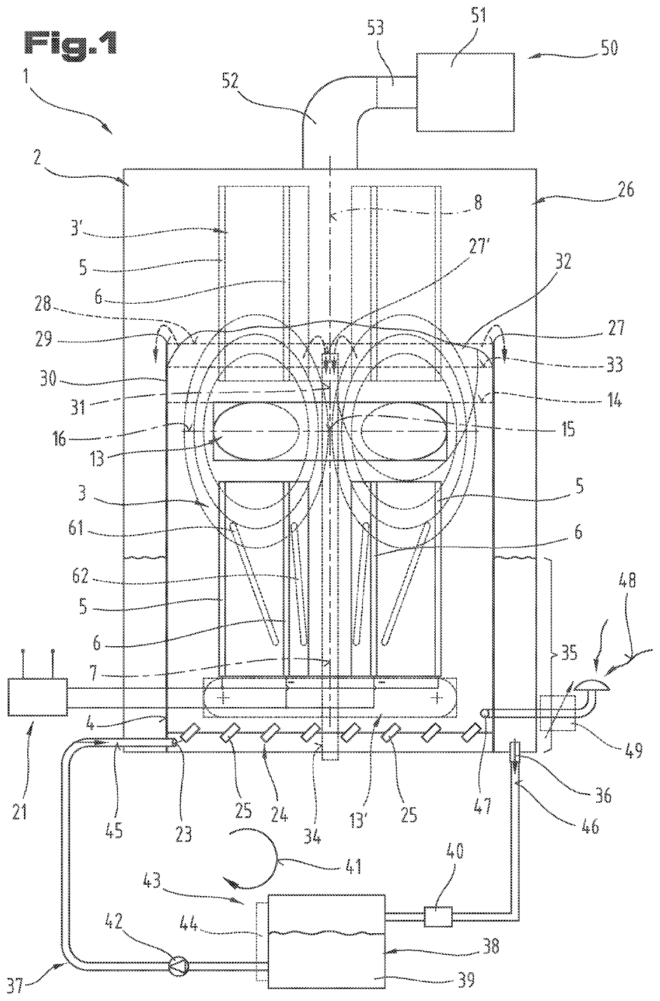

FIG. 1 is a schematic diagram of an embodiment of the electrolytic reaction system 1 illustrated with a view to its basic, technical design. It should explicitly be pointed out that not all the measures illustrated therein constitute part of the subject matter of the invention. Individual ones of the design and/or process measures shown in FIG. 1 may naturally also be applied to the exemplary embodiments described below.

The specified electrolytic reaction system 1 is used to generate gaseous hydrogen and oxygen by applying the electrolysis method. In particular, an electrolyte, in particular water or an aqueous electrolyte, in particular a mixture of water and an additive, such as sulfuric acid, to increase its conductivity for example, are split by an electrolytic process into gaseous hydrogen and gaseous oxygen and/or converted into a corresponding gas mixture by means of the electrolytic reaction system 1 during its operation.

In a manner known per se, such an electrolytic reaction system 1 comprises at least one reaction chamber 2 for accommodating and/or storing an aqueous or water-based electrolyte, as well as at least one electrode arrangement 3 made up of a plurality of anodic and cathodic electrodes.

The reaction chamber 2 is preferably formed by an essentially hollow cylindrical holding container 4, in which at least one electrode arrangement 3 is arranged. Based on a first embodiment, this electrode arrangement 3 is formed by a plurality of plate-shaped electrodes 5, 6 fanned out in a star-shaped arrangement. In this regard, mutually adjacent electrode plates 5, 6 thus alternately form a cathode and an anode. The consecutive alternating polarity of the individual electrodes 5, 6 for forming consecutive cathodes and anodes is known in electrolytic systems. Instead of the plate-shaped electrodes 5, 6 fanned out in a star shape, it is also possible, according to a further embodiment, to use electrodes of the type with a hollow body, in particular prismatic and/or tubular electrodes, which will be described below.

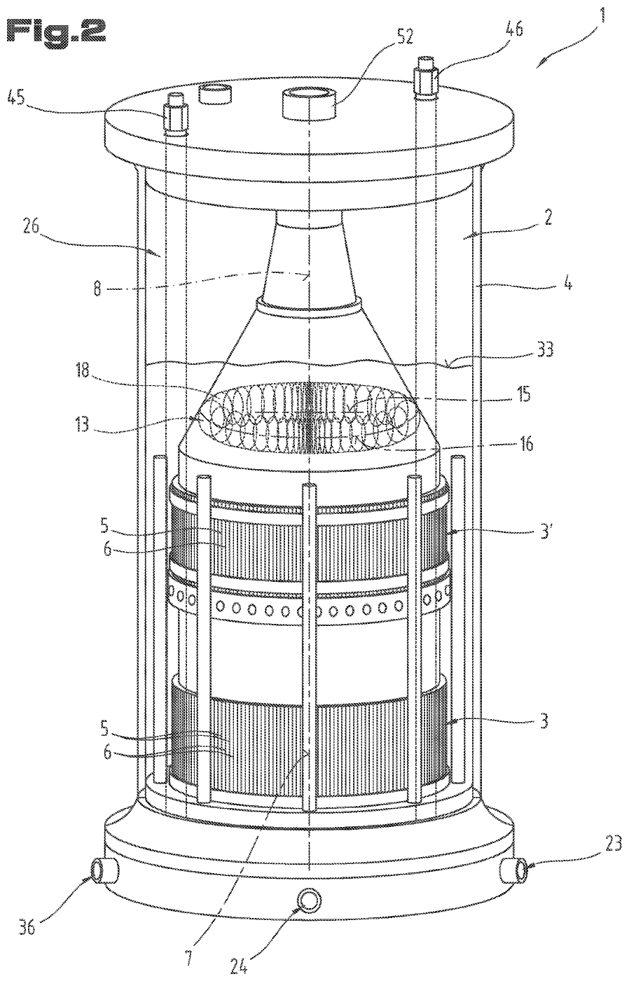

In this embodiment with electrode plates 5, 6 fanned out in a star shape and/or extending in a radiating arrangement, a virtual fanning axis 7 of this electrode arrangement 3 is oriented and/or positioned essentially on a virtual cylinder and/or vertical axis 8 and/or essentially congruently with the cylinder and/or vertical axis 8 of the holding container 4, as may be seen by combining FIGS. 2 and 3. In this regard, the individual plate-shaped electrodes 5, 6 are oriented vertically, i.e. the flat faces of the individual electrode plates 5, 6 are oriented in a wall-like manner and are spaced apart from one another by a relatively short distance of 0.5 mm to 15 mm, preferably 1 mm to 5 mm. A thickness of the plate-shaped electrodes 5, 6 is 0.1 mm to 5 mm, preferably approximately 1 mm.

As may best be seen from FIG. 3, a varying distance 9, 9′ lies between adjacent electrode plates 5, 6 of the star-shaped and/or fan-shaped electrode arrangement 3. This varying distance 9, 9′ between directly adjacent electrode plates 5, 6 is a result of the star-shaped and/or fan-shaped course of the individual, plate-shaped electrodes 5, 6 with respect to a common virtual fanning axis 7 of this electrode arrangement 3. In particular, the individual electrode plates 5, 6 extend from the common virtual fanning axis 7 in the radial direction towards the fanning axis 7. Seen in a plan view — according to FIG. 3—the electrodes 5, 6 are oriented in a V-shape. Consequently, in each case there is a spread angle 10, in particular a so-called mid-point angle and/or a degree measure a, between directly adjacent electrode plates 5, 6, which depends on the number of pairs of electrode plates 5, 6 arranged about the fanning axis 7 in a circular and/or radiating arrangement, as may clearly be seen in FIG. 3. Due to this star-shaped arrangement of the respective electrode plates 5, 6 and the varying distances 9, 9′ which occur depending on the distance from the fanning axis 7, the effectiveness of the electrolysis process is assisted. In particular, better allowance can be made for the different water qualities and/or different conductivities of the electrolyte due to the varying distance 9, 9′ and/or due to the defined spread angle 10 between adjacent electrode plates 5, 6. In particular, a highly efficient and/or high-performance electrolysis process can be implemented even if different and/or gradually fluctuating or drifting water qualities are present and/or if their conductivity differs. This means that the specified star-shaped embodiment is relatively insensitive in terms of varying water qualities and/or in terms of varying conductivities or with respect to other physical properties which change during the duration and/or course of the electrolysis process. Furthermore, these measures favor and/or support the degassing of the electrolysis products, in particular hydrogen and oxygen, from the electrode arrangement 3. This results in higher efficiency and/or a higher electrolysis performance within a defined period of time. Based on one practical embodiment, the distance 9 between adjacent electrodes 5, 6 in an end section lying closest to the fanning axis 7 is approximately 0.6 mm, and the distance 9′ in the end section facing away from the fanning axis 7 is approximately 4 mm.

Seen in plan view, the star-shaped electrode arrangement 3 is preferably circular in terms of its contour. However, a polygonal contour would also be conceivable. Based on one particularly practical embodiment, the star-shaped and/or fan-shaped electrode arrangement 3 has a circular design when seen in plan view, as may best be seen from FIG. 3. In particular, a cylindrical or tubular gap 11 may be provided around the fanning axis 7, which gap 11 may be completely filled with the electrolyte and/or at least partially function as a discharge chamber and/or overflow or discharge channel for excess or overflowing electrolyte fluid or for electrolyte foam, as will be explained in more detail below. In other words, the individual electrode plates 5, 6 are fanned and/or arranged consecutively about the fanning axis 7, preferably keeping a defined radial distance 12 and are therefore oriented radially with respect to the fanning axis 7, as can be seen best in FIG. 3. Viewed as a whole, an electrode arrangement 3 based on this design has an essentially hollow-cylindrical body, as may be seen in a combination of FIGS. 2 and 3. In this regard, this hollow-cylindrical electrode body has a plurality of electrode plates 5, 6 with different poles layered in a lamellar arrangement but spaced apart from one another, extending in a fence and/or radiating arrangement around the common cylinder and/or fanning axis 7. In this regard, the individual plate-shaped electrodes 5, 6 constitute the imaginary beams of the star-shaped electrode arrangement 3 radiating out from the fanning axis 7, as it were, when seen in plan view.

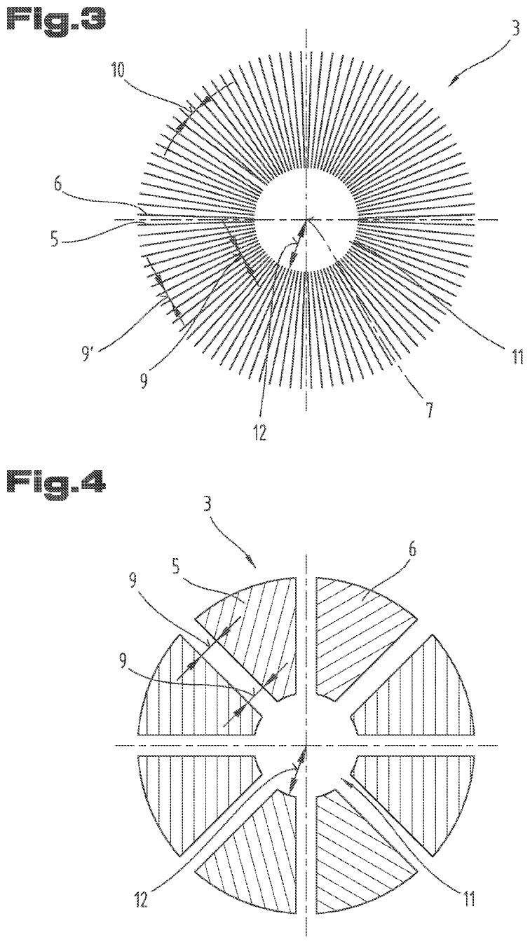

The individual electrode plates 5, 6 have a uniform and/or constant thickness and/or width with respect to the opposing flat faces of the plate electrodes. Instead of forming plate-shaped electrodes 5, 6, it is also possible to form electrodes 5, 6 essentially shaped like a circular sector when the electrode arrangement 3 is seen in plan view, in particular circle sector-shaped anodes and cathodes, as schematically illustrated in FIG. 4 by way of example.

These electrodes 5, 6 with the shape of a circle sector when seen in plan view or cross-section are also arranged about a common fanning axis 7. The individual circle sector-shaped electrodes 5, 6 are preferably arranged at a radial distance 12 from the fanning axis 7. In this regard, as well, a star-shaped and/or fan-shaped arrangement of the electrode plates 5, 6, which are circle sector-shaped and/or approximately circle sector-shaped when viewed in cross section, is provided — as illustrated in 4. This electrode arrangement 3, as well, therefore has an essentially hollow-cylindrical body shape because a cylindrical and/or tubular gap 11 is preferably formed around the virtual and/or imaginary fanning axis 7. Unlike the embodiment illustrated in FIG. 3, however, a distance 9 between adjacent electrodes 5, 6 is constant or approximately constant in terms of different radial distances from the fanning axis 7, as may be seen from FIG. 4.

At least one electromagnetic coil 13 is arranged in the axial direction of the virtual cylinder and/or vertical axis 8, i.e. in the axial direction of the vertical axis of the holding container 4, preferably at least above and/or underneath the electrode arrangement 3, which has a star-shaped design. In this regard, the electromagnetic field generated by this electromagnetic coil 13 when exposed to electrical energy acts on the electrolyte and also on the electrode arrangement 3 in the reaction chamber 2. This means that the coil 13 is arranged and/or dimensioned such that the field lines of the electromagnetic field intersect and/or influence the electrolyte and also the anodic and cathodic electrodes 5, 6 of the electrode arrangement 3.

Preferably, the at least one electrode arrangement 3 is completely submersed in the electrolyte, which is preferably formed by water or an aqueous solution. However, the at least one electromagnetic coil 13 is preferably also arranged below a regular and/or minimum fluid level 14 for the electrolyte. This means that the electromagnetic coil 13 for generating an electromagnetic field is preferably also arranged at least predominantly, preferably completely, submersed in the electrolyte. This is important in terms of transmitting vibrations and/or high frequency vibrations to the electrolyte on the one hand and at least indirectly also to the anodic and cathodic electrodes 5, 6 on the other hand and to thus support and/or accelerate the detachment of gas bubbles on the electrodes 5, 6 and degassing of the hydrogen and/or oxygen bubbles from the liquid electrolyte. In particular, the electromagnetic field of the at least one coil 13 causes the anodic and cathodic electrodes 5, 6 of the electrode arrangement 3 to be mechanically vibrated such that the detachment of gas bubbles developing on the anodic and cathodic electrodes 5, 6, in particular the respective oxygen and hydrogen bubbles, is supported. Additionally, the electromagnetic field of the at least one electromagnetic coil 13 causes ionization and enhances and/or intensifies the electrolytic process.

The anodic and cathodic electrodes 5, 6 are made from a ferromagnetic material, in particular one which can be influenced by magnetic fields, e.g. metals containing iron and/or precious metals, for example the so-called Nirosta metal, or from any other stainless steel. Due to the high-frequency, mechanical vibrations of the electromagnetic coil 13, which are of a relatively low amplitude, the detachment of the gas on the electrodes 5, 6 is enhanced and/r accelerated. At the same time, the active surface of the electrodes 5, 6 is held as high as possible relative to the electrolyte in order to keep high and/or maximize the effectiveness and/or the productivity of the electrolytic process and/or the electrode surfaces of the electrodes 5, 6.

This accelerates the electrolysis process and/or improves and/or maximizes the breaking down process as a function of a defined period of time. In other words, the electrolytic performance or break-down performance of the electrolytic reaction system 1 can be improved and/or enhanced. In particular, the conversion work and/or breaking down work done per unit of time is increased by means of the described measures so that even with reaction systems 1 with a relatively small volume and/or with a compact build, high discharge outputs of hydrogen and oxygen gas and/or with respect to a corresponding gas mixture can be obtained. The specified electrolytic reaction system 1 therefore offers a high degree of reactivity and/or rapid reactions. The at least one electromagnetic coil 13 at least partially submersed in the electrolyte therefore offers a synergy effect because it causes ionization one the one hand and acts as a means of generating vibrations for the electrolyte and/or for the electrodes 5, 6 on the other hand.

According to an advantageous alternative or advancement, a further electrode arrangement 3′ comprising a plurality of anodic and cathodic electrodes 5, 6 is arranged above the at least one electromagnetic coil 13. This further electrode arrangement 3′ arranged above the electromagnetic coil 13 is also preferably completely, in particular as completely as possible, submersed in the liquid, in particular the aqueous electrolyte inside the reaction chamber 2.

As it was schematically and/or principally adumbrated by way of example in FIG. 1, the electromagnetic fields of the electromagnetic coil 13 exposed to energy act on the electrodes 5, 6 of the electrode arrangement 3, 3′ arranged underneath and/or above in a vibrating manner, and/or the electromagnetic coil 13 exposed to energy also acts on the electrolyte with vibrations and/or oscillations, so that gas bubbles are detached from the electrodes 5, 6 and/or a movement of the gas bubbles in the electrolyte is supported and/or enhanced.

Alternatively, it is also conceivable to arrange the electromagnetic coil 13 underneath the electrode arrangement 3, in particular in the base section of the reaction chamber 2 and/or holding container 4 accommodating the electrolyte.

The electrode arrangement 3 is preferably arranged at a vertical distance from the base section and/or base plate of the reaction chamber 2. Due to this, there is a defined electrolyte volume disposed underneath the electrode arrangement 3 and/or a defined quantity of electrolyte is able to accumulate underneath the electrode arrangement as a result, and a flow channel close to the base is created underneath the electrode arrangement 3. An electromagnetic coil 13′ positioned in an axial direction towards the cylinder and/or vertical axis 8 underneath the electrode arrangement 3 is preferably likewise positioned at a distance from the base section of the reaction chamber 2 to enable a flow to be created in the electrolyte inside the electrode arrangement 3 starting from the base section and moving upwards in the vertical direction, in particular in the direction towards the gas chamber of the electrolytic reaction system 1.

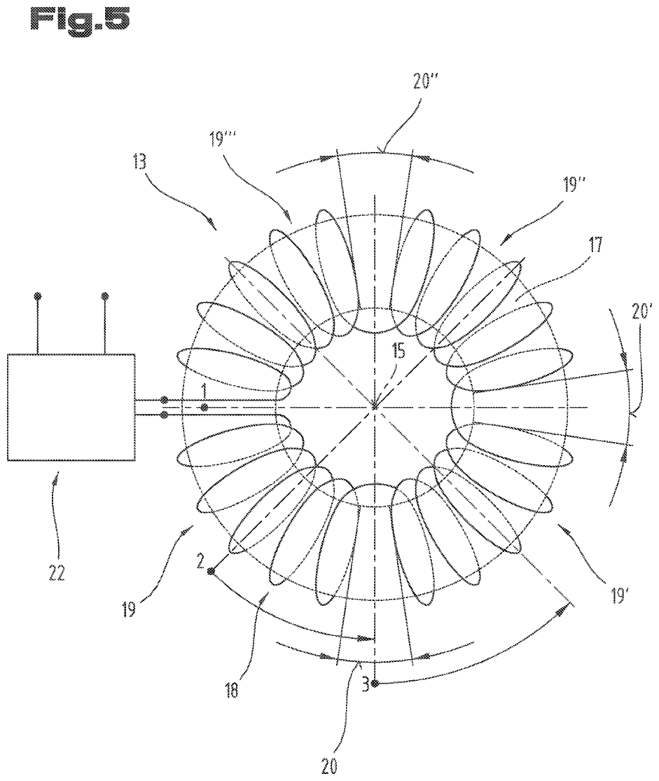

According to an advantageous embodiment, which may be seen from a combination of FIGS. 1 and 5, the at least one electromagnetic coil 13 as seen in plan view is essentially of an annular shape. In this regard, a central and/or mid-point 15 of this torus-shaped electromagnetic coil 13 lies on or close to the cylinder and/or vertical axis 8 of the holding container 4 and/or on or close to the fanning axis 7 of the electrode arrangement 3. In other words, the essentially disk-shaped mid-plane 16 of the coil 12 is oriented transversely to, in particular at a right angle to, the cylinder and/or vertical axis 8 or at a right angle to the fanning axis 7, as may best be seen from FIG. 1.

A coil body 17 of the coil 13 preferably has an annular and/or torus-shaped design. This coil body 17 is preferably made from a non-magnetizable material, in particular from plastic or such like. In other words, the electromagnetic coil 13 is preferably designed without an iron core, and in particular is provided in the form of an air coil. This coil body 17 supports at least one coil winding 18 comprising a plurality of turns, in particular hundreds or thousands of turns, wound around the coil body 17. Instead of forming a coil body 17, however, it is also possible for the at least one coil winding 18 to be based on a self-supporting design, i.e. formed without a coil body 17, in which case it is virtually of an intrinsically stable design.

The individual turns of the coil winding 18 are oriented radially and/or essentially radially with respect to the annular coil 13. In particular, the individual turns extend in a circle and/or coil around the bead-type coil body 17, as best illustrated in FIG. 5. Based on a preferred embodiment, four part-windings 19, 19′, 19″, 19′″ are formed, arranged so as to be distributed around the circumference of the coil body 17 and/or coil 13, each wound so as to be at a distance from one another. The individual part-windings 19-19′″ are connected in series. A winding distance 20, 20′, 20″ is preferably formed between the individual part-windings 19-19′″.

According to one advantageous embodiment, three coil windings are formed, each arranged offset from the coil axis and/or central and/or mid-point 15 by 45°, wound one on top of the other. In particular, this results in an at least three-layered coil winding 18, the winding distances 20, 20′, 20″ of which are arranged one after the other and/or offset from one another in the circumferential direction of the torus-shaped coil 13.

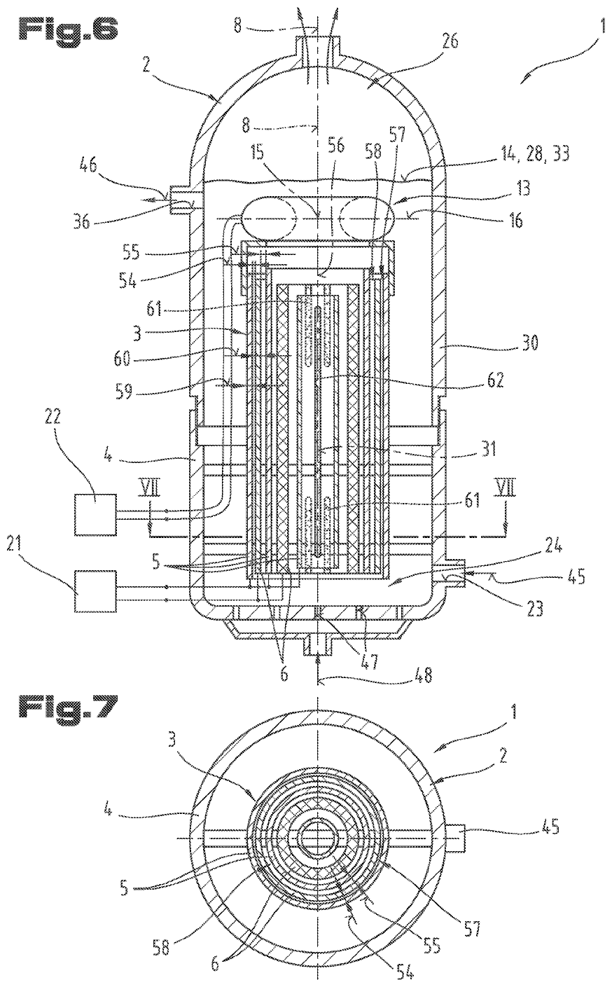

According to one advantageous embodiment, the at least one electromagnetic coil 13 is connected to the electrode arrangement 3 so as to disperse load and/or is supported so that it takes the load away from the electrode arrangement 3. This means that the at least one electromagnetic coil 13 is not mechanically connected directly to the reaction chamber 2, for example, but instead is mechanically connected as directly as possible to the electrode arrangement 3. This makes it possible for the vibrations to be transmitted as intensively as possible to the electrode arrangement 3. In the case of the embodiment illustrated in FIG. 2, the electromagnetic coil 13 is accommodated in a hollow-conical and/or funnel-shaped retaining element, which retaining element is supported on the top face of the electrode arrangement 3. Mechanical oscillations or vibrations of the electromagnetic coil 13 are thus transmitted to the electrode arrangement 3 and vice versa. In the case of the embodiment according to FIGS. 6, 7, the at least one electromagnetic coil 13 is secured and/or supported by means of a clamp-type support and/or retaining device on the top face of the electrode arrangement 3 so that it takes load.

The electrodes 5, 6 are expediently retained and/or mounted such that they are able to oscillate in the electrolyte bath as freely as possible. To this end, a one-ended and/or tongue-type retaining and/or mounting is favorable. Alternatively, it is conceivable to retain the electrodes 5, 6 on at most two mutually opposite edge sections and/or terminal ends of the electrodes 5, 6, as illustrated by way of example in FIG. 2.

The individual anodic and cathodic electrodes 5, 6 of the electrode arrangement 3 are supplied, in a manner known per se, with electrical energy from a first electrical energy source 21. In this regard, the first energy source 21 is preferably designed to provide the anodic and cathodic electrodes 5, 6 with pulsating energy supply.

The at least one electromagnetic coil 13 is supplied with electrical energy by a further electrical energy source 22. The further electrical energy source 22 is preferably designed to provide the at least one electromagnetic coil 13 with a pulsating energy supply.

The first energy source 21 and the further energy source 22 supply the electrodes 5, 6 and/or the coil 13 preferably with a pulsating DC voltage of varying amplitude level and defined impulse pauses between the individual voltage and/or energy impulses in each case. The energy sources 21, 22 are preferably formed by electrical energy transformers, in particular by transformer circuits and/or signal generators, of a type long known from the prior art. The respective energy sources 21, 22 are supplied with electrical energy from a public power supply network or preferably from a DC voltage source, in particular from an electrochemical voltage source, e.g. an accumulator. The electrical energy supplier for the energy sources 21, 22 is preferably formed by an accumulator, in particular by at least one lead accumulator with a terminal voltage of 12V and/or 24V. In particular, the energy supplier may be formed by the 12V/24V on-board network of an automotive vehicle.

According to one advantageous measure, an energy frequency of the first energy source 21 supplying energy to the anodic and cathodic electrodes 5, 6 compared with an energy frequency of the second energy source 22 supplying energy to the at least one electromagnetic coil 13 is selected such that the electrolytic reaction system 1 operates close to or at its resonance frequency, at least some of the time. In particular, the respective energy frequencies of the first energy source 21 and the further energy source 22 are adapted to one another such that the electrolytic system operates in a resonant or quasi resonant state, thereby offering a highly efficient and/or highly active breakdown of the electrolyte into gaseous hydrogen and oxygen. As a result, amongst other things, the degree and/or efficiency with which the respective gas bubbles are detached from the anodic and cathodic electrodes 5, 6 is significantly influenced. In particular, the effect of the electric and/or electromagnetic fields in the reaction chamber 2 assists and/or accelerates an electrolytic splitting process on the one hand. On the other hand, a vibration and/or oscillation is generated due to the electromagnetic coupling of forces and/or vibrations in the electrolyte and/or in the metallic, in particular ferromagnetic, electrodes 5, 6, which is conducive to detaching gas and hence the breakdown and/or splitting process.

In this regard, the impulse frequency of the first energy source 21 supplying the anodic and cathodic electrodes 5, 6 is a multiple higher than the impulse and/or energy frequency of the second energy source 22 supplying the at least one electromagnetic coil 13. The supply frequency of the first energy source 21 is at least from a hundred times up to approximately ten thousand or a hundred thousand times that of the supply frequency of the second energy source 22, preferably approximately a thousand times. The frequency ratio between the electrical energy supply for the electrode arrangement 3 and the electrical energy supply for the at least one electromagnetic coil 13 is therefore preferably approximately 1000:1. For example, the energy frequency for the coil 13 is approximately 30 Hz and the energy frequency for the anodic and cathodic electrodes 5, 6 is approximately 30 kHz. Naturally, other base and/or frequency values could be set and/or generated at the energy sources 21, 22.

A voltage level of the first energy source 21 supplying the anodic and cathodic electrodes 5, 6 may be several 100 V.

The respective voltage and/or frequency values will primarily depend on the structural arrangement and geometric dimensions of the respective components inside the reaction chamber 2 and can be adjusted and/or adapted empirically and/or in the context of the skills of the person skilled in the art.

According to one advantageous embodiment, at least one inlet orifice 23 for filling up and/or continuously or discontinuously refilling electrolyte fluid is arranged in the bottom section of the reaction chamber 2, in particular of the electrolyte volume and/or of the holding container 4 for the electrolyte. Due to the electrolyte which is and/or can be fed in at the base section, in particular the base section of the electrolyte bath, a turbulence and/or swirling occurs in the electrolyte fluid, which advantageously assists and/or accelerates detachment of the gas bubbles from the anodic and cathodic electrodes 5, 6.

Alternatively to or in combination with this, at least one means 24 for creating turbulence in the electrolyte, in particular for creating a flow in the electrolyte, for example a turbulent flow, may be formed in the reaction chamber 2, in particular in the holding container 4 for the electrolyte. This turbulence-creating means 24 may be formed by any measures known from the prior art for creating flows and/or turbulence in a liquid bath. One advantageous embodiment provides that the means 24 for creating turbulence in the electrolyte is provided in the form of intake and/or outlet nozzles 25 for the electrolyte running into the reaction chamber.

A plurality of intake and/or outlet nozzles 25 is preferably provided for the electrolyte, which are preferably assigned to the holding container 4 for the electrolyte. Depending on the turbulence and/or distribution of the respective turbulent forces required, the number of these intake and/or outlet nozzles 25 may vary considerably to suit the relevant requirements. Also depending on the diameter of these intake and/or outlet nozzles 25, at least two or also hundreds of such intake and/or outlet nozzles 25 may be formed, preferably in the base region of the holding container 4 for the electrolyte. According to one advantageous embodiment, at least individual ones of the effective axes of a plurality of intake and/or outlet nozzles 25 are inclined with respect to the base section. In particular, the effective axes of the intake and/or outlet nozzles 25 may be oriented at an angle with respect to the cylinder and/or vertical axis 8 of the reaction chamber 2 in order to build up an intrinsic turbulence and/or extensive flow in the electrolyte bath, which is conducive to removing the hydrogen and/or oxygen bubbles from the anodic and cathodic electrodes 5, 6 and/or from the interior of the electrolyte in the direction towards the top to the degassing zone, in particular a gas chamber 26 of the reaction chamber 2.

Instead of creating pronounced turbulence and/or flow in the electrolyte by introducing liquid and/or gas, it is naturally also possible to form the means 24 for creating turbulence in the electrolyte in the form of at least one agitator, which is immersed in the electrolyte fluid. According to one advantageous measure, the means 24 for forcing a flow in the electrolyte is designed such that an approximately helical flow is created around the cylinder and/or vertical axis 8 of the holding container 4 and/or reaction chamber 2, wherein the direction in which this helical flow is propagated extends from the base section of the electrolyte in the direction towards the surface of the electrolyte bath.

According to one advantageous embodiment, at least one overflow edge 27 is provided in the reaction chamber 2, which is designed to mark a maximum fluid level 28 of the electrolyte. According to one advantageous embodiment, this at least one overflow edge 27 is provided in the form of at least one top boundary edge 29 of a hollow-cylindrical and/or hollow-prismatic electrolyte container 30. This electrolyte container 30 preferably has a vertically oriented cylinder axis 31, which is preferably congruent and/or at least approximately congruent with the cylinder and/or vertical axis 8 of the reaction chamber 2. The at least one overflow edge 27 may, as an alternative or in addition to the top boundary edge 29 of the electrolyte container 30, be formed by at least one bore or some other orifice in the lateral surface of the electrolyte container 30. However, the top section of the electrolyte container 30 is preferably as open as possible, in particular across the entire cross-sectional surface, to facilitate efficient separation and/or removal of a foam 32 which usually develops during the electrolysis process, in particular a whitecap of foam which forms on the electrolyte. Especially if the fluid and/or electrolyte level lies at the same height as the overflow edge 37, and efficient removal of the foam 32 from the electrolyte is effected. An initial filling level 33 of the electrolyte preferably lies slightly below the overflow edge 27. During an active electrolytic process, the volume of electrolyte increases significantly, primarily due to the formation of gas bubbles in the electrolyte. This means that during the operation of the electrolytic reaction system 1, the electrolyte level in the reaction chamber 2, in particular in the holding and/or electrolyte container 4, 30, rises. It is for this reason that an initial filling level 33 for the electrolyte is preferably determined to fall below the overflow edge 27 of the electrolyte container 30. The overflow edge 27 in any event defines the maximum possible electrolyte level in the electrolyte container 30. When this maximum electrolyte level is reached and/or exceeded, the electrolyte foam or the whitecap of foam is efficiently removed.

According to the shown exemplary embodiment, the whitecap of foam and/or the foam 32 or also the overflowing and/or excess electrolyte fluid is discharged from the central region of the electrolyte container 30 in the outward direction, in particular in the radial direction towards the vertical and/or cylinder axis 8, 31. According to an alternative or combined embodiment, it is also possible for foam 32 and/or the electrolyte flowing over the at least one overflow edge 27 to be discharged via a discharge passage 34 arranged in a central region of the electrolyte container 30, as adumbrated by dashed lines. In this central and/or centrally arranged discharge passage 34, electrolyte and/or electrolyte foam spilling over the overflow edge 27′ can be directed in the downward direction and preferably gated back into the electrolyte container 30, as will be explained in more detail below.

A collection section 35 for electrolyte or electrolyte foam which has flowed over the overflow edge 27 is preferably formed in the base section of the reaction chamber 2. This collection section 35 extends across a defined vertical height of the reaction chamber 2 and prevents and/or reduces the electrolytically obtained gases from escaping through an outlet orifice 36 used to feed the electrolyte out of the reaction chamber 2 in a controlled manner. This collection section 35 may be provided in the form of a defined electrolyte level in the base section of the reaction chamber 2 or by some other siphon-type gas barrier. The collection section 35 or corresponding liquid siphon primarily ensures that the reaction chamber 2 is closed in a gas-tight manner as far as possible and/or that hydrogen and oxygen gas is prevented as far as possible from escaping or being discharged through an outlet orifice 36 for the electrolyte close to the base. The siphon-type collection section 35 for electrolyte fluid and/or for separated electrolyte foam flowing over the overflow edge 27 therefore closes the outlet orifice 36 off so that it is relatively gas-tight, whereas the electrolyte fluid can still be discharged in a controlled manner from the reaction chamber 2 through the at least one outlet orifice 36. Particular care must be taken to ensure that a defined fluid level exists and/or is built up within the collection section 35 in order to produce a sufficiently gas-tight gas barrier.

The fluid level in the collection section 35 is preferably lower than the regular filling level 33 for the electrolyte inside the electrolyte container 30. As illustrated, the collection section 35 may be formed around the electrolyte container 30 or, if the excess electrolyte is introduced centrally into a centrally arranged discharge passage 34, be provided in the central region of the electrolyte container 30, as shown with the aid of the embodiment variant illustrated in dashed lines. Alternatively, a combined outer and inner collection or also a cascaded electrolyte collection can of course also be realized in order to separate and degas electrolyte foam and/or electrolyte fluid by means of at least one collection section 35 for electrolyte fluid.

It is also useful to provide at least one return line 37 for the electrolyte flowing over the overflow edge 27 of the holding and/or electrolyte container 4, 30. The electrolyte is fed back into the hollow-cylindrical and/or hollow-prismatic electrolyte container 30 or into the reaction chamber 2 by means of this return line 37. Within the at least one line incorporating the return line 37 for the electrolyte, it is also preferable to provide a liquid tank 38, in particular a water container 39, in which a certain quantity of electrolyte, in particular a liquid electrolyte in the form of water, can be held in supply and/or buffered. Electrolyte fluid is fed from this liquid tank 38 to the electrolytic process inside the reaction chamber 2 continuously or discontinuously. The at least one return line 37 extends more or less through and/or via the liquid tank 38. This means that the return line 37 opens into the liquid tank on the one hand and that the return line 37 continues on from the liquid tank 38 again in the direction towards the reaction chamber 2 to provide a means of filling and/or refilling the electrolytic fluid in the holding and/or electrolyte container 4, 30. This electrolyte circuit 41 between the reaction chamber 2 and the liquid tank 38 and/or the water container 39 is comparable with the intake and return lines of fuel supply systems used in internal combustion engines from a hydraulic point of view.

In this regard, at least one filter device 40 for filtering out residues, in particular impurities, in the electrolyte and/or in the electrolytically treated water may be arranged in the return line 37. In order to create an active and/or forced water and/or electrolyte circuit 41, at least one fluid pump 42 may be incorporated in the return line 37 and/or in the intake line for the electrolyte with respect to the reaction chamber 2. It is useful if the return line 37 also serves as a cooling device 43 for the electrolyte and/or comprises a cooling device 43. This cooling device 43 may be formed by the pipe connections of the return line 37 per se and/or may be formed by an additional heat exchanger, in particular an air/liquid exchanger, e.g. cooling fins. This heat exchanger 44 and/or cooling fins may be provided in the pipe connection and/or on the liquid tank 38 and/or water container 39. According to a preferred embodiment, the cooling device 43 is dimensioned and/or the return line 37 is dimensioned such that the temperature of the electrolyte is kept within a range of between 20° C. and 60° C., in particular in a range of between 28° C. and 50° C., preferably at 35° C. to 43° C. It is primarily within the specified temperature range of the electrolyte that the electrolysis process is optimized and/or relatively efficient. In particular, only a relatively small quantity of power in terms of electrical energy is needed in this temperature range. The cooling device 43 may naturally also be formed by other passively and/or actively operating cooling devices as they are known from many designs known from the prior art.

According to one advantageous embodiment, the electrolytic reaction system 1 therefore has a continuous or discontinuous intake 45 and discharge 46 for the electrolyte. In particular, this intake 45 and discharge 46 of the electrolyte provides and/or creates a time-based gradual replacement and/or refill of the electrolyte comprising water or formed by water in the reaction chamber 2 and/or in its electrolyte container 30. In this respect, it is preferable to create a closed electrolyte circuit 41 in which the liquid tank 38 and the at least one fluid pump 42 is implemented.

According to one advantageous measure intended to improve the system, at least one passage orifice 47 for ambient air 48 to be introduced into the reaction chamber 2, in particular into the holding container 4 for the electrolyte, is formed, preferably in the base section and/or in the casing region of the reaction chamber 2. Alternatively or in addition to this, the at least one passage orifice 47 may also be provided as a means of feeding nitrogen or other non-combustible gases into the holding container 4, in particular into the electrolyte container 30. The at least one passage orifice 47 then opens directly into the electrolyte bath, which is arranged in the reaction chamber 2, in particular in the electrolyte container 30, during operation of the reaction system 1. A plurality of passage orifices 47 for ambient air 48 and/or nitrogen is provided in a distributed arrangement, preferably in the base section and/or casing region of the electrolyte container 30. In particular, ambient air 48 and/or nitrogen is fed and/or introduced directly into the electrolyte so that a liquid and/or gas mixture and a flow and/or turbulence is created in the electrolyte. A regulating means 49 may optionally be provided, in particular a valve arrangement or similar, which is designed to regulate the quantity and/or pressure of the ambient air 48 and/or nitrogen flowing into the electrolyte. This process of introducing ambient air 48 and/or nitrogen or other non-combustible gases preferably takes place under pressure. In other words, the ambient air 48 and/or the oxygen is actively blown into the electrolyte. Another option would be to generate a negative pressure in the reaction chamber 2 to enable the appropriate gases or gas mixtures, such as air, to be sucked in. As a result of the passage orifices 47 described above, by means of which ambient air 48 and/or nitrogen is blown and/or introduced directly into the electrolyte, the process of detaching oxygen and/or hydrogen bubbles adhered to the electrode arrangement 3 is supported on the one hand. In addition, introducing this air and/or nitrogen into the electrolyte can be used as a means of creating turbulence and/or mixing the electrolyte. This has a positive effect in terms of the electrolytic performance, in particular in terms of the efficiency of the electrolytic reaction system 1.

It is preferable to provide a multiple arrangement of passage orifices 47 by means of which air and/or nitrogen can be introduced into the holding container 4 for the electrolyte in a selective and distributed manner According to one advantageous embodiment, these passage orifices 47 are positioned in the base section of the reaction chamber 2, in particular underneath the electrode arrangement 3.

According to one advantageous measure intended to improve the system, the electrolytic reaction system 1 is assigned at least one means 50 for generating negative pressure inside the reaction chamber 2, in particular in its gas chamber 26. In this regard, this negative pressure should be interpreted by reference to atmospheric ambient pressure. In other words, means 50 generating the negative pressure inside the reaction chamber 2, in particular in the gas chamber 26, create defined negative pressure conditions. According to a first embodiment, this means 50 may be provided in the form of a vacuum pump. According to one advantageous embodiment, this means 50 for generating negative pressure may be formed by a consumer for the chemical energy carrier hydrogen, connected to the reaction chamber 2. This consumer, which in the case of one advantageous embodiment is formed by an internal combustion engine 51, in particular a petrol, gas or diesel engine, converts the chemical energy of the hydrogen into kinetic energy by releasing thermal energy. The consumer may naturally also be formed by any heating or generator system for generating power. According to one advantageous embodiment, negative pressure is built up in the reaction chamber 2 by establishing a flow connection 52 between the reaction chamber 2, in particular its gas chamber 26, and a fuel intake line 53, in particular the intake passage of an internal combustion engine 51 or some other combustion system for converting the chemical energy of the hydrogen-oxygen mixture into thermal and/or kinetic energy. This also increases degassing performance with respect to the electrolyte and the electrode arrangement 3 and increases the electrolysis performance which can be achieved with the electrolytic reaction system 1.

FIGS. 6, 7 illustrate another embodiment of the electrolytic reaction system 1 for generating gaseous hydrogen and oxygen. This may also be construed as an independent embodiment of the reaction system 1 proposed by the invention in its own right. In this regard, equal reference numbers and/or component designations are used for equal parts as in the Figs. preceding it. In order to avoid unnecessary repetitions, it is pointed to/reference is made to the detailed description of the preceding figures. It is explicitly pointed out that not all the features and/or structural measures illustrated in these figures necessarily form part of the reaction system 1 according to the invention. Moreover, combinations of features with features from the preceding figures may constitute embodiments according to the invention.

This electrolytic reaction system 1 also comprises a reaction chamber 2 for accommodating an electrolyte, such as water, an aqueous solution, or a water mixture together with additives to increase conductivity, for example. Also arranged in the reaction chamber 2 is at least one electrode arrangement 3, formed of a plurality of anodic and cathodic electrodes 5, 6. In the case of this embodiment, the electrode arrangement 3 is formed by at least two, preferably more than at least three, tubular electrodes 5, 6 arranged coaxially or approximately coaxially one inside the other. In the shown exemplary embodiment, five tubular electrodes 5, 6 arranged coaxially, nested one inside the other, in particular inserted one inside the other, are formed. In this context, it should be pointed out that electrodes 5, 6 with circular and/or annular or elliptical cross-sections are preferred. However, instead of tubular electrodes 5, 6 with a hollow-cylindrical body shape, it would naturally also be possible to use tubular electrodes 5, 6 with a prismatic body shape, in particular with square, rectangular or any other polygonal cross section. The individual electrodes 5, 6 preferably form, in each case, alternating and/or consecutive anodes and cathodes in the electrolytic reaction system 1.

The lateral surfaces of the mutually adjacent tubular electrodes 5, 6, which lateral surfaces may be cylindrical or made up of multiple prismatic surfaces oriented at an angle to one another, are spaced apart from one another. In particular, defined distances 54 and/or 55 are arranged between the respective cylindrical and/or lateral surfaces, in particular between the internal and external faces of the respective electrodes 5, 6. According to one advantageous measure, a distance 54 or a gap dimension between the tubular or hollow-prismatic electrodes 5, 6 nested in one another is dimensioned to be increasing or to be becoming larger starting from an outer pair of electrodes 5, 6 compared to an electrode 5, 6 arranged further inwards, in particular closer to the central tube axis 56, or a pair of electrodes 5, 6 of this tubular electrode arrangement 3 arranged further inwards. In other words, distances 55 between tubular and/or hollow-prismatic electrodes 5, 6 at the center of the electrode arrangement 3 are preferably of bigger dimensions than the distances 54 between outer pairs of electrodes 5, 6 and/or those surrounding the inner electrodes 5, 6.

The individual, virtual tube axes 56 of the tubular electrodes 5, 6 are preferably oriented vertically. This being the case, each of the distal end sections of the tubular electrodes 5, 6 are of an open design. The individual tubular electrodes 5, 6 preferably have a constant cross-sectional surface by reference to their length and/or height.

Between the lateral or cylinder surfaces of the tubular and/or hollow-prismatic electrodes 5, 6, at least one at least approximately hollow-cylindrical or prismatic gap 57, 58 is formed. Due to the at least one gap 57, 58 between the various electrodes 5, 6 of the electrode arrangement 3, the formation of gas bubbles is made possible and/or is supported. In particular, gas bubbles which occur and/or adhere to the anodic and cathodic electrodes 5, 6 during the electrolysis process can be efficiently fed away into a gas chamber 26 lying above the electrolyte. A sort of suction effect occurs as a result and supports the release of gas bubbles from the electrolyte. This effect is reinforced by the electrolyte volume arranged underneath the electrode arrangement 3 and by a Venturi effect inside the tubular electrode arrangement 3.

In particular, the at least one approximately hollow-cylindrical or prismatic gap 57, 58 between adjacent electrodes 5, 6 creates a sort of chimney flue effect for the gas bubbles and thus increases the rate at which they are released and/or the degassing performance. This effect is further enhanced by the cascaded and/or multiple arrangement of electrodes and/or electrode pairs 5, 6.

At least one electromagnetic coil 13 is arranged at least above the tubular electrode arrangement 3 with respect to the virtual central tube axis 56, as already described above. The essential aspect is that when energy is applied to this electromagnetic coil 13, the preferably alternating and/or pulsating electromagnetic field which occurs and/or is generated act on the electrolyte and also on the electrode arrangement 3. In particular, the field lines intersect both the electrode arrangement 3 and the electrolyte volume in the electrolytic reaction system 1 with sufficient intensity. Alternatively or in combination with an electromagnetic coil 13 lying above the electrode arrangement 3, at least one electromagnetic coil 13 may also be formed underneath the electrode arrangement 3.

Amongst other things, the at least one electromagnetic coil 13 causes the electrode arrangement 3 to mechanically oscillated and/or vibrate, which supports and/or accelerates release of the gas bubbles from the electrolyte. In addition, the electric field of the electromagnetic coil 13 also has a positive effect on the electrolytic conversion and/or splitting process above all.

According to one advantageous embodiment, the reaction chamber 2 of the electrolytic reaction system 1 has an essentially hollow-cylindrical or hollow-prismatic body shape. In this regard, the virtual cylinder and/or vertical axis 8, in particular the lateral surface of the reaction chamber 2, is vertically or at least approximately vertically oriented, as may be seen in FIG. 6 or FIG. 2 for example.

As may also best be seen from FIGS. 2 and 6, it is useful if the reaction chamber 2 comprises and/or has an essentially hollow-cylindrical or hollow-prismatic holding container 4, in which the at least one star-shaped or tubular electrode arrangement 3 is arranged. According to the embodiment according to FIGS. 1, 2, the holding container 4 for the electrolyte and for the at least one electrode arrangement 3 is of an open design at the top end section. In addition, its lateral and/or cylinder surface is spaced at a distance apart from the inner wall faces of the reaction chamber 2, as may best be seen from FIG. 1. This offers a simple way of forming the separation and/or collection section 35 described above. According to one advantageous measure, the virtual fanning axis 7 of the star-shaped electrode arrangement 3 and/or the virtual tube axis 56 of the tubular electrode arrangement are essentially congruent with the virtual cylinder axis 8 or congruent with the virtual cylinder axis 8 of the holding container 4 and/or the reaction chamber 2, as may be seen in particular from the diagrams of FIGS. 1 and 6.

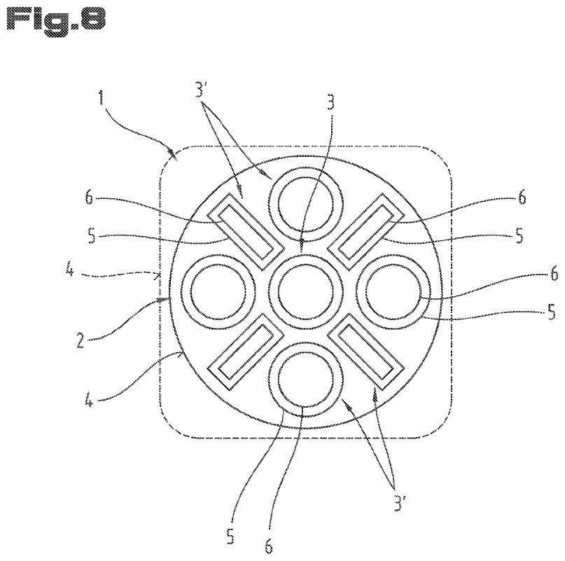

FIG. 8 shows a further schematic and/or basic representation of an electrode arrangement 3. In this case, the holding container 4 and/or reaction chamber 2 are hollow cylindrical, in particular circular in terms of their cross-section. According to an alternative embodiment indicated by dashed lines, the reaction chamber 2 and/or the holding container 4 may also have a different hollow-prismatic body shape, in particular a cross-sectional shape with corners, although, however, rounded corners and/or edge regions are advantageous. Provided in the interior of the reaction chamber 2 is a plurality of electrode arrangements 3, 3′. In particular, a bundle of tube electrodes is formed, wherein the individual electrode pairs 5, 6 are arranged in a distributed arrangement inside the holding container 4 for the electrolyte. In particular, a first electrode arrangement 3 is formed at the center of the holding container 4 and, placed in a circle around this central electrode arrangement 3 is a plurality of further electrode arrangements 3′. It would also be possible to use mixed shapes of electrodes. For example, tube electrodes 5, 6 with a circular cross-section and tube electrodes 5, 6 with a square cross-section could be combined, for example as a means of obtaining a higher packing density inside the holding container 4.

As regards the dimensioning of the tubular and/or hollow-prismatic electrodes 5, 6, it is useful to ensure that their stiffness values do not exceed a defined upper threshold value if possible. In particular, the wall thicknesses 59, 60 of the electrodes 5, 6 should be selected so that the electromagnetic field of the at least one coil 13 induces mechanical oscillations in the electrode arrangement 3 and/or at least individual electrodes 5, 6. Since the electrodes 5, 6 are made from electrically conducting, in particular ferromagnetic, material, the electromagnetic alternating field and/or the electromagnetically pulsating field of the at least one coil 13 has the effect of inducing vibrations and/or oscillations. This is conducive to efficient detachment of gas bubbles and/or the capacity of the gas bubbles to be released from the electrolyte. In particular, the material elasticity and/or the wall thickness 59, 60 of the respective electrodes 5, 6 should be selected so that the most intensive oscillations possible are induced by the electromagnetic coil 13.

According to one advantageous embodiment and with a view to enhancing this detachment process, the at least one plate-shaped electrode 5, 6—FIG. 1—or the at least one tubular or hollow-prismatic electrode 5, 6—FIG. 6—may be provided with at least one slot 61, 62 and/or a plurality of orifices or perforations. In particular, the respective electrodes 5, 6 have at least one mechanical weakening and/or reduction in stiffness, such as slots 61, 62 or orifices or cutouts in the material and/or material conservations, so as to made to oscillate more mechanically intensively under the influence of the electromagnetic field of the at least one electromagnetic coil 13. These features also enhance the performance and/or reaction time of the electrolytic reaction system 1 in terms of efficiency in providing hydrogen. However, an intensive inducement of vibrations and/or one involving as little loss as possible for the electrodes 5, 6 is also obtained by means of a load-transmitting support, in particular due to an as rigid as possible mechanical connection between the at least one electromagnetic coil 3 and at least one electrode 5, 6 of the electrode arrangement 3. This mechanical connection and/or retaining device is preferably electrically insulating.

As defined in accordance with the invention, the electrode arrangement 3 is formed of at least one bundle of tubular electrodes coaxially nested one inside the other. This enables optimum electrolysis performance to be obtained. However, it would also be conceivable to produce similar actions and/or effects with other electrode arrangements known from the prior art, for example with a cascaded and/or serial arrangement of plate-shaped electrodes, so that the electrode arrangements according to the claims need not necessarily be the ones used. In particular, only relatively low impairment of performance and/or efficiency is to be anticipated if using electrode arrangements of different types.

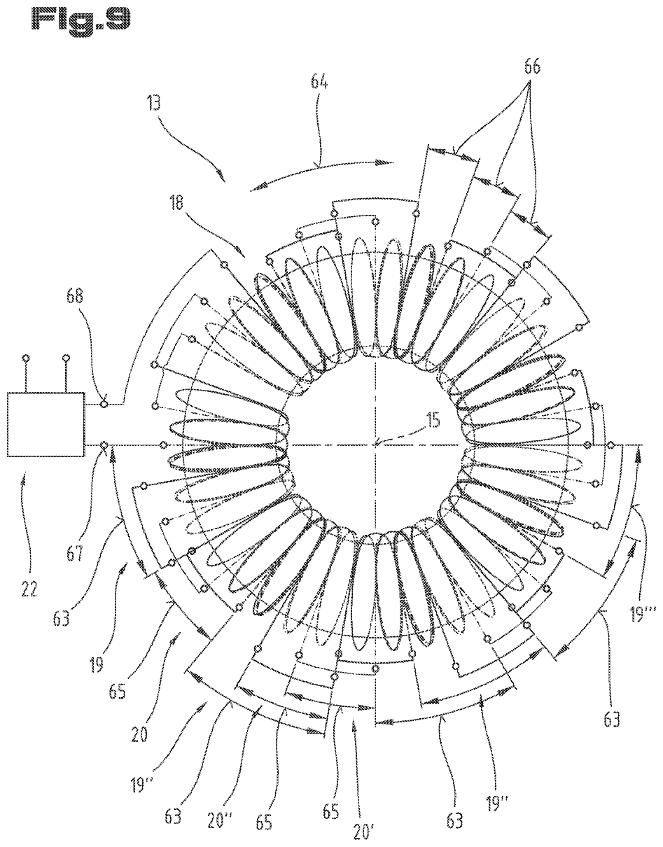

FIG. 9 illustrates a further embodiment of the at least one electromagnetic coil 13 which can advantageously be used with the electrolytic reaction system 1 in the manner explained above. This embodiment of the electromagnetic coil 13 can therefore be used in combination with the measures described above to obtain an advantageous electrolytic reaction system 1. In the following paragraphs, equal reference numbers and/or component designations are used for equal parts as in the Figures preceding it. In order to avoid unnecessary repetitions, it is pointed to/reference is made to the detailed description of the preceding figures.

The schematically illustrated electromagnetic coil 13 represents an alternative to the embodiment illustrated in FIG. 5 and, in keeping with the explanations given with reference to FIGS. 1, 2 and 6, is preferably arranged above and/or underneath a star-shaped or tubular electrode arrangement 3 so that its electromagnetic field acts on the electrolyte on the one hand and on the electrode arrangement 3 on the other hand when supplied with electrical energy.

The at least one electromagnetic coil 13 provided is essentially torus-shaped or annular and comprises a plurality of part-windings 19, 19′, 19″, 19′″ electrically connected in series. The individual part-windings 19, 19′, 19″, 19′″ of the electromagnetic coil 13 each extend across a circumferential angle 63 constituting only a fraction of the total ring circumference 64, i.e. a fraction of the 360° angle of the torus-shaped electromagnetic coil 13. The circumferential angle 63 of the individual part-windings 19, 19′, 19″, 19′ connected in series is typically between 20° and 50°, in particular between 25° and 45°, preferably approximately 30° with respect to the full ring circumference 64 of the coil 13.

The part-windings 19, 19′, 19″, 19′″ connected in series and arranged one after the other in the circumferential direction of the annular coil 13 form a free angle 65 with respect to one another, which corresponds to the winding distances 20, 20′, 20″, 20′″ described above. No electromagnetic coil is disposed within this free angle 65 between directly consecutive part-windings 19, 19′, 19″, 19′″ and instead virtually an empty space without an electromagnetic coil body is provided. This free angle 65 between directly consecutive part-windings 19, 19′, 19″, 19′″ connected in series is expediently between 10° and 30°, in particular between 15° and 25°, preferably approximately 20° . This free angle 65 or the corresponding winding distance 20, 20′, 20″, 20′ defines zones within the electromagnetic coil 13 in which different electromagnetic conditions prevail than in those zones of the electromagnetic coil 13 in which the serially consecutive part-windings 19, 19′, 19″, 19′ are arranged and/or positioned. The gaps without windings defined by the free angle 65 between the individual part-windings 19, 19′, 19″, 19′″ create a diversity within the electromagnetic field which is generated and/or can be generated by the electromagnetic coil 13, which is conducive to the electrolytic process in the electrolytic reaction system 1.

A particularly favorable design of the electromagnetic field which is generated and/or can be generated by the electromagnetic coil 13 is achieved if the circumferential angle 63 of the individual part-windings 19, 19′, 19″, 19′ and the free angle 65 between the individual part-windings 19, 19′, 19″, 19′″ are selected such that after more than one complete ring circumference, i.e. on exceeding 360° of winding extension, an offset angle 66 is formed between part-windings 19, 19′, 19″, 19′″ wound one on top of the other. This means that as a result, the part-windings 19, 19′, 19″, 19′″ of the first turn around the annular and/or torus-shaped coil 13 are offset from the part-windings 19, 19′, 19″, 19′″ of the second and/or every further ring of part-windings 19, 19′, 19″, 19′″ by an offset angle 66. Consequently, the part-windings 19, 19′, 19″, 19′″ lying one above the other in the circumferential direction of the annular coil 13 are always offset and/or shifted relative to one another so that there is preferably no 100% overlap between part-windings 19, 19′, 19″, 19′ wound one on top of the other.

According to one practical embodiment, a number of consecutive part-windings 19, 19′, 19″, 19′″connected in series is selected such that approximately three full turns around the ring are formed, i.e. the part-windings 19, 19′, 19″, 19′ connected in series extend approximately across 1080° of the annular and/or torus-shaped coil 13.

According to one practical embodiment, the individual part-windings 19, 19′, 19″, 19′″ are wound in one layer, wherein the part-windings 19, 19′, 19″, 19′″ formed after a complete turn round the ring are wound with the appropriate offset angle 66 but essentially without an air gap across part-windings 19, 19′, 19″, 19′″ lying underneath and/or inside.

The electromagnetic coil 13 preferably has no core, in particular does not have an electromagnetically active core. In particular, the electromagnetic coil 13 is provided in the form of an air coil so that the electromagnetic field generated acts to a high degree on the electrolyte and on the electrode arrangement 3 and thus influences the physical and chemical processes in the electrolytic reaction system 1 to a high degree.

A part-winding 19, 19′, 19″, 19′″ consists of a plurality of turns, in particular dozens, hundreds or thousands of turns made from an isolated conductor, in particular a copper wire insulated by means of lacquer. The preferably two-layered, in particular three-layered electromagnetic coil 13 comprising mutually spaced apart part-windings 19, 19′, 19″, 19′″serially connected to one another therefore has a first coil terminal 67 and a further coil terminal 68, between which the mutually spaced apart part-windings 19, 19′, 19″, 19′″ extending in a circle are formed. Via these coil terminals 67, 68, the electromagnetic coil 13 is connected to the electrical energy source 22, as explained in the earlier parts of the description. Accordingly, a diameter of the outer part-windings 19, 19′, 19″, 19′″ is bigger than a diameter of the inner part-windings 19, 19′, 19″, 19′″ of the annular and/or torus-shaped electromagnetic coil 13.

Instead of the schematically illustrated electrical connecting bracket between the directly consecutive part-windings 19, 19′, 19″, 19′, it is naturally also possible to wind the individual part-windings 19, 19′, 19″, 19′″ without interruption and/or in one piece, in particular from a one-piece electrical conductor, thereby obviating the need for the connecting bracket disposed in between.

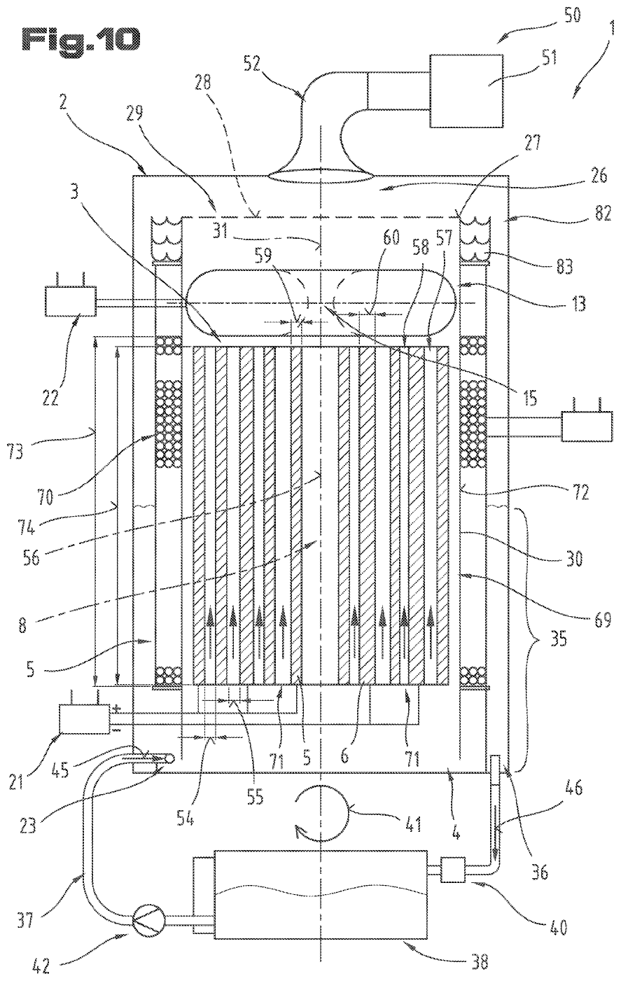

FIG. 10 shows a further exemplary embodiment of the electrolytic reaction system 1. For the components already described above, equal reference numbers were used, and the preceding parts of the description may be analogously transferred to equal components with equal reference numbers.

This electrolytic reaction system 1 is designed for highly efficient production of gaseous hydrogen and oxygen. It comprises an inner reaction chamber 69 for accommodating an electrolyte, an electrode arrangement 3 with a plurality of anodic and cathodic electrodes 5, 6, at least two electromagnetic coils 13, 70, and an electrolyte circuit 41, which is provided for recirculating the electrolyte and for fluidically guiding the electrolyte through the electrode arrangement 3. The flow of the electrolyte through the electrode arrangement 3 is supported and/or effected by at least one fluid pump 42. In particular, by means of the at least one fluid pump 42, a circulation of the electrolyte in the electrolytic reaction system 1 and/or an obligatorily imprinted flow in at least one flow channel 71 defined by the electrodes 5, 6 of the electrode arrangement 3 is obtainable.

The electrodes 5, 6 and the annular electromagnetic coil 13, which is positioned above and/or underneath the electrode arrangement 3, are situated within the preferably cylindrical inner reaction chamber 69. The further electromagnetic coil 70 has a hollow-cylindrical design and is attached to an outer lateral surface 72 of the electrolyte container 30, preferably wound on the lateral surface 72 directly and/or without gaps. The electrolyte container 30 which is open at the top defines the inner reaction chamber 69. The hollow-cylindrical electromagnetic coil 70 has an axial length and/or height 73, which corresponds approximately to a vertical length 74 of the electrode arrangement 3. The vertically oriented electromagnetic coil 70 is preferably installed along the entire vertical length 74 of the electrode 5, 6. All previously mentioned parts of the reaction system 1 are accommodated in the outer reaction chamber 2.

An improved efficiency of the electrolytic reaction system 1 is achieved by the specific design and/or orientation of the electrodes 5, 6, by the structural combination and technical interaction between the respective electrode arrangement 3 and the pulsed electromagnetic field of the electromagnetic coils 13, 70 arranged above and/or below the electrode arrangement 3 as well as outside around the electrode arrangement 3, as well as by the directed flow of the electrolyte.

The electrode arrangement 3 comprises multiple tubular, in particular hollow-cylindrical electrodes 5, 6, which are arranged coaxially inside one another at a consistent or different radial distance 54, 55. The center and/or the cylinder and/or vertical axis 8 of the electrode arrangement 3 is preferably congruent with the cylinder axis 31 of the electrolyte container 30. Electrodes 5, 6 which are directly adjacent in the radial direction are electrically insulated from one another and/or electrically coupled with one another depending on the conductivity of the electrolyte. A wall thickness 59, 60 of the electrodes 5, 6 is kept as low as possible. The limiting factor is a sufficient structural stiffness of the construction in order to prevent short circuits between the electrodes 5, 6. The wall thickness 59, 60 of the cylindrical electrodes 5, 6, for example, falls in a range of between 1 mm and 3 mm.

The electrodes 5, 6 are attached, on their bottom section, in the reaction chamber 69 in an electrically insulated manner They may also be held and/or supported with respect to one another by electrically insulated inserts in the top section. The flow channels 71 and/or the gaps 57, 58 with an annular cross-section between the directly adjacent electrodes 5, 6 are to be kept to a minimum. The radial distance 54, 55 between directly adjacent electrodes 5, 6 may fall in a range of between 1 mm and 3 mm.

The material of the electrodes 5, 6 is a metal or an alloy with good magnetic properties and an average or low overpotential which may also serve as a catalyst for improving the gas generating reaction. For example, a stainless steel with a high nickel content may be used.

A current supply unit and/or the energy source 21 delivers direct current or pulsed current to the electrodes 5, 6, wherein enough electrical potential is generated between two adjacent electrodes 5, 6 to maintain a high speed of the gas developing reaction. The pulsed current is preferably delivered in a frequency range of between 1 kHz and 200 kHz.

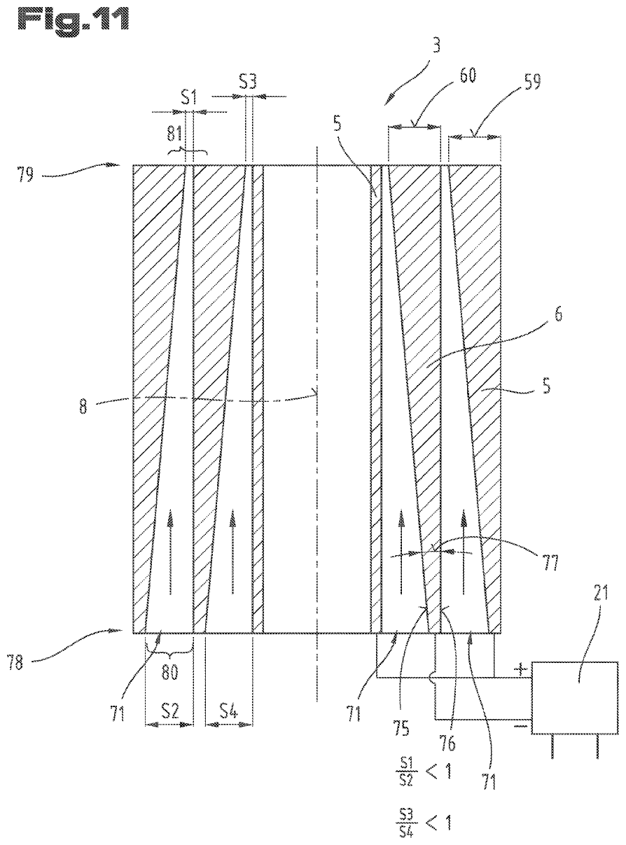

An advantageous embodiment of the electrolytic reaction system 1 consists in that the electrodes 5, 6 are formed to be tubular, in particular in the form of hollow-cylinders, wherein the radially inner and the radially outer lateral surface 75, 76 of at least one of the electrodes 5, 6 are inclined towards one another at at least a predefined angle 77, as can be seen by way of example in FIG. 11. The representation according to FIG. 11 shows a vertical section through the electrode arrangement 3.

In particular, it is useful if the cylindrical lateral surfaces 75, 76 or the lateral surfaces, composed of multiple surfaces oriented at an angle to one another, of the adjacently arranged tubular electrodes 5, 6 are arranged at a distance from one another and in this regard, form at least one flow channel 71 for the electrolyte between lateral surfaces 75, 76 of the electrodes 5, 6, the lateral surfaces 75, 76 being spaced apart from one another. Such a flow channel 71 extends between a first axial end 78 for admitting the electrolyte into the electrode arrangement 3 and a second axial end 79 for discharging the electrolyte out of the electrode arrangement 3. In this regard, it is essential that the at least one flow channel 71 has at least one first flow cross-section 80 and at least one second flow cross-section 81, wherein the second flow cross-section 81 has a smaller size than the first flow channel 80, and the comparatively smaller second flow cross-section 81 is formed in a partial section of the at least one flow channel 71 closest to the second axial end 79 of the electrode arrangement 3.

In the shown exemplary embodiment, the comparatively smaller second flow cross-section 81 and/or the generally smallest flow cross-section 81 of the at least one flow channel 71 is formed directly on the second axial end 79 of the electrode arrangement 3. In this regard, the at least one flow channel 71 has a continuously tapering flow channel 80, 81 and/or one with a nozzle-shaped extension between the first and second axial end 79, 80 of the electrode arrangement 3. In particular, the at least one flow channel 71 may have a boundary contour which tapers in a wedge-shaped manner when viewed in the longitudinal section through the electrode arrangement 3, as is shown by way of example in FIG. 11. Thereby, as rational and economical a production as possible of the electrode arrangement 3 is made possible. Furthermore, the acceleration effect with respect to the electrolyte that is aimed for can be reliably obtained.

At least one or all of the electrodes 5, 6 may be produced such that one of its surfaces and/or lateral surfaces 75, 76, i.e. either the radially inner or the radially outer lateral surface 75, 76, has a side and/or lateral surface 75, 76 which is inclined at the predefined angle 77 with respect to a vertical. Thus, either the inner diameter of the axially bottom end of the tubular electrode 5, 6 is of greater dimension, in a defined ratio and/or extent, than the inner diameter of the axial upper end of the tubular electrode 5, 6. Alternatively, the outer diameter of the axially bottom end of the tubular electrode 5, 6 may be of smaller dimension, in a defined ratio and/or extent, than the outer diameter of the axially upper end of the tubular electrode 5, 6.

Due to this construction, the at least one flow channel 71 and/or the gap 57, 58 between the lateral surfaces of adjacent electrodes 5, 6, in which the electrolyte is present, has a flow cross-section 80, 81 that is changing and/or decreases towards the top. Thereby, the electrode arrangement 3 can be constructed as simply and cost-effectively as possible but still with an increased functionality. Preferably, the at least one gap 57, 58 between directly adjacent electrodes 5, 6 is at maximum and/or greater in the region of the bottom and/or first axial end 78 of the electrode device 3 and at minimum and/or smaller in the region of the top and/or second axial end 79. With respect to FIG. 11, it is true that: S1/S2<1, S3/S4<1.

According to an alternative embodiment, both the radially inner lateral surface 75 and the radially outer lateral surface 76 of at least one of the electrodes 5, 6 may be formed to be inclined with respect to the vertical at a uniform or different angle 77. In particular, it may be provided that the radially inner and the radially outer lateral surface 75, 76 of at least one electrode 5, 6, which is/are arranged between a radially innermost and a radially outermost electrode 5, 6 of the electrode arrangement 3, is/are formed to be angled and/or inclined with respect to the central axis and/or with respect to the cylinder and/or vertical axis 8 of the electrode arrangement.

Thus, it is useful if the radially inner and/or the radially outer lateral surface 75, 76 on and/or of at least one of the electrodes 5, 6 is formed in the form of a lateral surface of a frustum.

Furthermore, it may be provided that the tapering flow cross-section 81 is formed between the lateral surfaces 75, 76 of directly adjacent electrodes 5, 6 by a wall thickness 59, 60 of at least one of the electrodes 5, 6, which wall thickness 59, 60 increases steadily or abruptly from the first axial end 78 towards the second axial end 79 of the electrode 3.

According to the exemplary embodiment shown in FIG. 11, it may also be provided that the radially innermost, tubular electrode 5 and/or 6 of the electrode arrangement 3 has a consistent wall thickness and a consistent outer diameter across its entire axial length. This may also apply to the radially outermost electrode 5 and/or 6.

Instead of or in combination with the described, conical and/or hollow-conical shaping of at least one of the electrodes 5, 6, it is also possible to form and/or intensify the at least one flow channel 71, which tapers in the flow direction of the electrolyte, by means of directly adjacent electrodes 5, 6 and/or electrode pairs oriented at an angle and/or an incline with respect to one another. In particular, the at least one flow channel 71 with a nozzle-type appearance may also be effected by longitudinal axes of at least two directly adjacent electrodes 5, 6 which extend at an angle and/or at an incline with respect to one another, in particular be realized by means of an acute-angle alignment and/or orientation of directly adjacent surfaces of electrodes 5, 6. The longitudinal axes are to be understood as the axes of the electrodes 5, 6 pointing in the flow direction and/or in the longitudinal direction of the flow direction 71.

Due to the shaped and/or orientation of the electrodes 5, 6, the typically turbulent of the electrolyte in the reaction chamber 2 accelerates upwardly. Its speed continuously increases, whereby the intensity of the separation of the gas bubbles from the surfaces of the electrodes 5, 6 is increased. Thereby, the effective surface of the electrodes 5, 6 is increased and/or kept as large as possible, and the ohmic resistance and/or potential drop in decreased, whereby the electrolysis process is improved.

The electrolyte is preferably continuously fed under pressure into the base section of the inner reaction chamber 69 and/or the base section of the electrode arrangement 3. The at least one inlet orifice 23 for the electrolyte moved in a circulatory manner may be arranged close to the inner surface of the inner reaction chamber 69 and be arranged at an acute angle to the surface of the inner reaction chamber 69. The electrolyte thereby assumes the properties of a directed flow, in particular one swirling in a turbulent manner, helically upwards.

The electrolyte also partially flows approximately helically between the electrodes 5, 6, wherein it rises starting from the base section of the inner reaction chamber 69 in the direction towards its upper edge, and supports and accelerates the detachment of the gas bubbles from the electrodes 5, 6. The directed electrolyte flow in combination with the magnetic field of the at least one electromagnetic coil 13, 70 induces an additional ion current in the electrolyte, which causes a higher current density and leads to an intensification of the process.

The active electrolyte circuit 41, which comprises the at least one fluid pump 43, also results in that the electrolyte flows preferably continuously or discontinuously over the upper overflow and/or boundary edge 27, 29 of the inner reaction chamber 69, in particular of the electrolyte container 30. Thereby, a kind of “electrolyte waterfall” develops, which facilitates degassing the electrolyte.

For intensifying the degassing process of the electrolyte, at least one degassing device 82 may be installed and/or formed on the outer surface of the inner reaction chamber 69, as it is shown schematically in FIG. 10. In particular, a degassing device 82 for the electrolyte may be provided after the overflow edge 27 of the holding container 4 when viewed in a flow direction of the electrolyte.

The degassing device 82 may comprise a series of multi-level cascades with a ripped surface, which make it possible to distribute the electrolyte fluid in a thin layer over the correspondingly enlarged surface and to thus ensure an intensive and effective degassing. According to a useful embodiment, the degassing device 82 may be formed by at least one distributing element 83 for the electrolyte extending in the radial direction to the cylinder and/or vertical axis 8, which distributing element 83 is provided for enlarging the surface of the electrolyte flowing over the overflow edge 27 or for forming a comparatively thin electrolyte fluid film on the distributing element 83. In this regard, the distributing element 83 may be arranged annularly around the holding container 4 and/or the electrolyte container 30 and be oriented so as to be inclined downwardly starting from its radially inner section in the direction towards its radially outer section, so that a gravity-based discharge of the gas-charged electrolyte takes place in the downward direction, in particular is ensured into the collection section 35.

The combination of the degassing device 82 and a negative pressure, which is generated by a consumer or its unit, for example a vacuum pump or a combustion chamber, intensively removes the electrolyte bubbles and/or the gases dissolved in the electrolyte, whereby the amount of gas delivered to the consumer, for example an internal combustion engine 51, is increased and the ohmic resistance of the electrolytic is decreased. Thereby, the factual cell tension is decreased and the energy balance of the process is improved. Shorter release times of the respective gases from the electrolyte are achieved, so that the electrodes 5, 6 and their effective surfaces are available to the electrolytic process to the greatest extent.

After the degassing process, the electrolyte reaches the inner cavity and/or the collection section 35 of the outer reaction chamber 2 and passes through the at least one outlet orifice 36 back into the electrolyte container 30. This takes place while interposing the fluid tank 43 with a reserve volume of electrolyte and possibly a filter device 40. Using the recirculation pump 42 and the at least one line-connected return line 37, the electrolyte is returned from the reserve volume of the fluid tank 43 into the electrolyte container 30 and/or to the electrode arrangement 3 at a predefined pressure.

A set of electromagnetic coils 13 and/or part-windings 19-19′ (FIG. 5 and/or 9) is arranged above and/or below the electrodes 5, 6. The vertically oriented, hollow-cylindrically designed electromagnetic coil 70 is wound on the cylindrical surface of the inner reaction chamber 69, which is formed of dielectric material, or on a dielectric hollow-cylindrical core, which is arranged in the axial direction of the cylinder and/or vertical axis 8 around the inner reaction chamber 69. The electromagnetic coils 13, 70 are preferably completely submersed in the electromagnetic coil during operation of the electrolytic reaction system 1.

In the following, reference is made to the electromagnetic units according to FIG. 5 and/or FIG. 9: The electromagnetic coils 13 and/or their part-windings 19-19′ (FIG. 5 and/or 9), which are situated above the electrodes 5, 6 and—as an option — underneath the electrodes 5, 6, are wound on a common dielectric ring core. The part-windings 19-19′ are connected in series with preferably 20 degrees intermediate spaces and/or winding distance 20-20″ between adjacent part-windings 19-19′. Each part-winding 19-19′ is wound in a fixed and gap-free manner with a maximum number of windings per length and/or circumferential unit. The part-windings 19-19′″ have a layered structure. Each part-winding 19-19′ has an uneven number of winding layers.

The electromagnetic coils 13 and/or their part-windings 19-19′″ are connected to the current supply and/or energy source 22, which delivers pulsed energy in the range of 1 to 100 Hz. The electromagnetic field of the electromagnetic coil 13 and/or of its part-windings 19-19′ acts on the electrolyte and on the electrode arrangement 3 when they are exposed to energy, whereby the current density and thus the efficiency of the electrolysis process is increased.

During operation, the at least one electromagnetic coil 13 and/or its part-windings 19-19′ generate a pulsed, irregular magnetic field. The magnetic field of the adjacent part-windings 19-19′″ overlaps in the air gap and/or within the winding distances 20-20″ between the part-windings 19-19′″, whereby its strength is increased. The pulsed magnetic field in combination with the moving electrolyte induces an addition movement of the ions in the electrolyte, which leads to a higher current density between the electrodes 5, 6 and increases the efficiency of the gas generating process.

The pulsed electromagnetic field also introduces micro vibrations of the electrodes 5, 6 and creates shock waves in the electrolyte, which remove the gas bubbles more intensively from the electrodes 5, 6 and thus reduce the overpotential and/or the overvoltages at the electrodes 5, 6. Applied overvoltage energy usually gets lost in the form of heat and thus does not contribute to material conversion.

The vertical hollow-cylindrical coil 70 is mounted on the cylindrical surface of the inner reaction chamber 69 made of dielectric material. The vertical height of the hollow-cylindrical coil 70 falls in the same range as the vertical height of the electrodes 5, 6. The pulsed energy supply is not guaranteed in a power supply unit which operates in a frequency range of 1 to 100 Hz.

During operation of the vertical electromagnetic coil 70, the electrode 5, 6 assume the properties of the metal core of this coil 70. The magnetic flux flowing through the inner reaction chamber 69 changes with time and thus leads to an electromagnetic induction at the electrodes 5, 6. As the electrodes 5, 6 are electrically insulated from one another and are radially situated on different diameters, they also receive different electrical potentials, whereby the potential difference between the electrodes 5, 6 develops, which enhances the electrolytic process. Furthermore, a synergy effect is achieved in the region of the interaction between the electromagnetic fields of the hollow-cylindrical electromagnetic coil 70 and the electromagnetic fields of the annular coil(s) 13, which synergy effect enhances the described effect.

The magnetic fields of the upper/lower magnetic coils 13 and the vertical electromagnetic coil 70 induce a drag, which has an effect on the gas bubbles in the electromagnetic coil and supports the detachment of the bubbles from the electrode surface. The detachment speed of the bubbles is accelerated. The increasing detachment speed reduces the dwell time of the bubbles on the surface of the electrodes 5, 6 and decreases the bubble coverage, whereby the overpotential and/or the overvoltage on the electrodes 5, 6 is reduced and the efficiency of the gas generation is improved. In the meantime, the reduction of the ohmic resistance and/or of the voltage drop on the insulating bubble layer on the electrode surface is achieved.

The interaction between the electromagnetic fields of the electromagnetic coils 13, 70 and the local current density induces an additional electrolyte flow which influences the generation of hydrogen and oxygen gas. The increased current density results in a higher hydrogen production with lower energy requirements. The magnetically induced flow reduces the diffusion layer thickness and improves the mass transport in the electrolyte. The interaction between the pulsed, irregular magnetic field and the moving electrolyte leads to a magnetohydrodynamic convection of the electrolyte, whereby the efficiency of the electrolysis system may be improved and the energy consumption may be reduced.

The exemplary embodiments show possible embodiment variants of the electrolytic reaction system 1, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field. Thus, any and all conceivable embodiment variants, which are possible by combining individual details of the embodiment variants shown and described, are also covered by the scope of protection.

For the sake of good order, it is finally pointed out that, for improved understanding of the construction of the electrolytic reaction system 1, the latter or the constituent parts thereof have in part been illustrated not to scale and/or on an enlarged scale and/or on a smaller scale.

The object underlying the independent inventive solutions may be gathered from the description.

In particular, the individual embodiments shown in FIGS. 1; 2; 3; 4; 5; 6, 7; 8; 9; 10, 11 may form the subject matter of independent solutions according to the invention. The respectively applicable problems and solutions according to the invention emerge from the detailed descriptions of said figures.

### LIST OF REFERENCE NUMBERS

1 Reaction system 34 Discharge passage
2 Reaction chamber 35 Collection section
3 Electrode arrangement
3′ Electrode arrangement
4 Holding container
5 Electrode (anodic)
6 Electrode (cathodic)
7 Fanning axis
8 Cylinder and/or vertical axis
9, 9′ Distance
10 Spread angle
11 Clearance
12 Radial distance
13 Electromagnetic coil
14 Fluid level (min.)
15 Central and/or mid point
16 Central plane
17 Coil body
18 Coil winding
19 Part-winding
19′ Part-winding
19″ Part-winding
19′″ Part-winding
20 Winding distance
20′ Winding distance
20″ Winding distance
21 Energy source
22 Energy source
23 Inlet orifice
24 Means (turbulence)
25 Intake and/or outlet nozzles
26 Gas chamber
27 Overflow edge
28 Fluid level (max.)
29 Boundary edge
30 Electrolyte container
31 Cylinder axis
32 Foam
33 Filling level
34 Discharge passage
35 Collection section
36 Outlet opening
37 Return line
38 Liquid tank
39 Water container
40 Filter device
41 Electrolyte circuit
42 Fluid pump
43 Cooling device
44 Heat exchanger
45 Intake
46 Discharge
47 Passage
48 Ambient air
49 Regulating means
50 Means (generating negative pressure)
51 Internal combustion engine
52 Connection
53 Fuel intake line
54 Distance
55 Distance
56 Tube axis
57 Gap
58 Gap
59 Wall thickness
60 Wall thickness
61 Slot
62 Slot
63 Circumferential angle
64 Ring circumference
65 Free angle
66 Offset angle
67 Coil terminal
68 Coil terminal
69 Inner reaction chamber
70 Hollow-cylindrical coil
71 Flow channel
72 Outer lateral surface
73 Axial height
74 Vertical length
75 Inner lateral surface
76 Outer lateral surface
77 Angle
78 First axial end
79 Second axial end
80 First flow cross-section
81 Second flow cross-section
82 Degassing device
83 Distributing device

1-48. (canceled)

49. An electrolytic reaction system (1) for generating gaseous hydrogen and oxygen, comprising
a reaction chamber (2, 69) for accommodating an electrolyte,
an electrode arrangement (3) in the reaction chamber (2, 69), which electrode arrangement (3) is formed of a plurality of anodic and cathodic electrodes (5, 6),
wherein the electrode arrangement (3) is formed by tubular electrodes (5, 6) arranged coaxially or approximately coaxially, wherein the cylindrical lateral surfaces or lateral surfaces, composed of multiple surfaces oriented at an angle to one another, of the adjacently arranged tubular electrodes (5, 6) are arranged at a distance from one another by at least one gap (57, 58), so that at least one flow channel (71) for the electrolyte is formed between the lateral surfaces of electrodes (5, 6) spaced apart from one another, which flow channel (71) extends between a first axial end (78) for admitting the electrolyte into the electrode arrangement (3) and a second axial end (79) for discharging the electrolyte from the electrode arrangement (3),
wherein the at least one flow channel (71) has at least one first flow cross-section (80) and at least one second flow cross-section (81), wherein the second flow cross-section (81) has a smaller size than the first flow channel (80),
and wherein the comparatively smaller second flow cross-section (81) is formed in a partial section of the at least one flow channel (71) located closer to the second axial end (79) of the electrode arrangement (3)
wherein
the at least one gap (57, 58) between directly adjacent electrodes (5, 6) is at maximum and/or greater in the region of the bottom, as viewed in the vertical direction, first axial end (78) of the electrode device (3) than in the region of the top, as viewed in the vertical direction, second axial end (79) of the electrode arrangement (3), and this at least one gap (57, 58) is at minimum or smaller in the region of the top, as viewed in the vertical direction, second axial end (79) of the electrode arrangement (3).

50. The electrolytic reaction system according to claim 49, wherein the tapering flow cross-section (81) is formed by a wall thickness (59, 60) of at least one of the electrodes (5, 6), which wall thickness (59, 60) steadily or abruptly increases from the first axial end (78) in the direction towards the second axial end (79).

51. The electrolytic reaction system according to claim 49, wherein a radially inner and/or a radially outer lateral surface (75, 76) of at least one electrode (5, 6), which is arranged between a radially innermost and a radially outermost electrode (5, 6) of the electrode arrangement (3), is/are formed to be inclined with respect to a cylinder and/or vertical axis (8) of the electrode arrangement (3).

52. The electrolytic reaction system according to claim 49, wherein the radially innermost, tubular electrode (5, 6) of the electrode arrangement (3) has a consistent wall thickness (59) and a consistent outer diameter across its entire vertical length (74).

53. The electrolytic reaction system according to claim 49, wherein a radially inner and/or a radially outer lateral surface (75, 76) of at least one of the electrodes (5, 6) is formed in the form of a lateral surface of a frustum.

54. The electrolytic reaction system according to claim 49, wherein the at least one tapering flow channel (71) is formed by longitudinal axes extending inclined with respect to one another of at least two directly adjacent electrodes (5, 6).

55. The electrolytic reaction system according to claim 49, wherein in the axial direction of a virtual cylinder and/or vertical axis (8) of the electrode arrangement (3), at least one electromagnetic coil (13) is arranged above and/or below the electrode arrangement (3), the electromagnetic field of which acts on the electrolyte and on the electrode arrangement (3) when supplied with electrical energy.

56. The electrolytic reaction system according to claim 49, wherein in the reaction chamber (2), an essentially hollow-cylindrical or hollow-prismatic hollow-cylindrical (4), in particular an electrolyte container (30) is formed, in which the at least one tubular electrode arrangement (3) is arranged.

57. The electrolytic reaction system according to claim 56, wherein the electrolyte container (30) or the holding container (4) for the electrolyte and for the at least one electrode arrangement (3) is designed to be open in the upper end section and the lateral and/or cylinder surface of which is arranged so as to be spaced apart from the inner wall surfaces of the reaction chamber (2).

58. The electrolytic reaction system according to claim 49, wherein a virtual tube axis (56) of the tubular electrode arrangement (3) essentially lies on the virtual cylinder and/or vertical axis (8) or is congruent with the virtual cylinder and/or vertical axis (8) of the holding container (4) and/or the reaction chamber (2).

59. The electrolytic reaction system according to claim 55, wherein the at least one electrode arrangement (3) is completely submersed in the electrolyte, and the at least one electromagnetic coil (13, 70) likewise lies below a regular or minimal fluid level (14) for the electrolyte or is at least largely submersed in the electrolyte.

60. The electrolytic reaction system according to claim 55, wherein the electromagnetic field of the at least one electromagnetic coil (13, 70) makes the anodic and cathodic electrodes (5, 6) oscillate mechanically such that a detachment of gas bubbles forming on or adhering to the anodic and cathodic electrodes (5, 6) is supported.

61. The electrolytic reaction system according to claim 55, wherein the at least one electromagnetic coil (13) has an annular design in a top view, and its central and/or mid point (15) lies one or close to the virtual cylinder and/or vertical axis (8) of the electrode arrangement (3).

62. The electrolytic reaction system according to claim 61, wherein the electromagnetic coil (13) has a torus-shaped design, and has at least one coil winding (18), preferably at least two, in particular four part-windings (19, 19′, 19″, 19′″) arranged so as to be distributed around the circumference of the coil body (17), each wound so as to be spaced apart from one another.

63. The electrolytic reaction system according to claim 49, wherein at least one inlet orifice (23) for introducing and/or filling up the electrolyte is arranged in the bottom section of the reaction chamber (2, 69) or of a holding container (4) accommodating the electrolyte.

64. The electrolytic reaction system according to claim 49, wherein at least one means (24) for creating turbulence in the electrolyte, in particular for creating a flow, for example a turbulent or whirl-like flow, in the electrolyte is formed in the reaction chamber (2, 69) or in a holding container (4) accommodating the electrolyte.

65. The electrolytic reaction system according to claim 64, wherein the means (24) for creating a turbulence is formed by at least one intake and/or outlet nozzle (25), preferably by a plurality of intake and/or outlet nozzles (25) for the electrolyte leading into the reaction chamber (2, 69) or in the holding container (4) of the electrolyte.

66. The electrolytic reaction system according to claim 65, wherein the at least one intake and/or outlet nozzle (25) is arranged in the vicinity of the inner lateral surface of the reaction chamber (3) or of the holding container (4) and is oriented at an angle to the inner lateral surface, so that a turbulently whirling flow can be generated in the electrolyte.

67. The electrolytic reaction system according to claim 49, wherein at least one overflow edge (27) for limiting or determining a maximum fluid level (28) of the electrolyte is formed in the reaction chamber (2, 69).

68. The electrolytic reaction system according to claim 67, wherein the at least one overflow edge (27) for the electrolytic is formed by an upper boundary edge (29) of a holding container (4), in particular of a hollow-cylindrical electrolyte container (30) with a vertically oriented cylinder axis (31).

69. The electrolytic reaction system according to claim 67, wherein at least one outlet orifice (36) is formed in the base section of the reaction chamber (2) for discharging electrolyte or electrolyte foam which has flowed over the overflow edge (27) out of the reaction chamber (2).

70. The electrolytic reaction system according to claim 67, further comprising a return line (37) for electrolyte which has flowed over the overflow edge (27) into the holding container (4), in particular in the hollow-cylindrical electrolyte container (30).

71. The electrolytic reaction system according to claim 67, further comprising a collection section (35) for electrolyte which has flowed over the overflow edge (27) inside the reaction chamber (2) or inside a return line (37) for the electrolyte leading into the reaction chamber (2), for forming a gas lock, in particular a siphon-type gas barrier for the generated hydrogen and oxygen.

72. The electrolytic reaction system according to claim 49, further comprising a continuous or discontinuous intake (45) and discharge (46) of the electrolyte, in particular by a time-based gradual replacement of the electrolyte comprising water or formed by water in the reaction chamber (2, 69) and/or in a holding container (4) accommodating the electrolyte.

73. The electrolytic reaction system according to claim 49, further comprising generating negative pressure in the reaction chamber (2) by establishing a fluidic connection (52) between the reaction chamber (2), in particular its gas chamber (26), with a fuel intake line (53), in particular the suction system, of an internal combustion engine (51), in particular a petrol, gas or diesel engine.

74. The electrolytic reaction system according to claim 55, wherein the at least one electromagnetic coil (13) has an essentially torus-shaped or annular design and comprises a plurality of electrically series-connected part-windings (19, 19′, 19″, 19″), each extending over a circumferential angle (63) of 20° to 50°, in particular between 25° to 45°, preferably approximately over 30° of the ring circumference (64) of the coil (13).

75. The electrolytic reaction system according to claim 49, wherein a one- or multi-layered electromagnetic coil (70) with a hollow-cylindrical design is attached on an outer lateral surface (72) of the reaction chamber (2, 69) or of the holding container (4), or on a dielectric winding carrier around the reaction chamber (2, 69) or the holding container (4), the electromagnetic field of which electromagnetic coil (70) acts on the electrolyte and on the electrode arrangement (3) when supplied with electrical energy.

76. The electrolytic reaction system according to claim 75, wherein an axial length (73) of the hollow-cylindrical, electromagnetic coil (70) corresponds at least approximately to a vertical length (74) of the electrode arrangement (3).

77. The electrolytic reaction system according to claim 67, wherein a degassing device (82) for the electrolyte is formed after the overflow edge (27) of the reaction chamber (69) and/or the holding container (4) when viewed in a flow direction of the electrolyte.

78. The electrolytic reaction system according to claim 77, wherein the degassing device (82) is formed by at least one distributing element (83) for the electrolyte extending in the radial direction to the cylinder and/or vertical axis (8), which distributing element (83) is provided for enlarging the surface of the electrolyte flowing over the overflow edge (27) or for forming an electrolyte fluid film on the distributing element (83).

79. The electrolytic reaction system according to claim 78, wherein the distributing element (83) is arranged annularly around the reaction chamber (69) and/or the holding container (4) and is oriented so as to be inclined downwardly starting from its radially inner section in the direction towards its radially outer section.

80. The electrolytic reaction system according to claim 78, wherein the distributing element (83) has a surface extending in a stair- or wave-shape for distributing and discharging the electrolyte.
